(19) United States
(12) Patent Application Publication
(10) Pub. No.: US 2025/0086490 A1
(43) Pub. Date: Mar. 13, 2025

(54) CONTROLLING FREQUENCY DEPENDENCE OF 0 GAUSS CLOCK STATE FREQUENCY ON BZ USING A MICROWAVE DRESSING FIELD

(71) Applicant: Quantinuum LLC, Broomfield, CO (US)

(72) Inventors: Robert Tyler SUTHERLAND, San Antonio, TX (US); Stephen Dale ERICKSON, Broomfield, CO (US)

(21) Appl. No.: 18/806,881

(22) Filed: Aug. 16, 2024

Related U.S. Application Data
(60) Provisional application No. 63/581,017, filed on Sep. 7, 2023.

(51) Int. Cl. G06N 10/40

(52) U.S. Cl. CPC G06N 10/40

(57) ABSTRACT

A controller of a quantum system causes a dressing field circuit to generate a dressing field at a target location where one or more target qubits are located. The dressing field modifies a set of initial states into a set of superposition states. A first (second) dressed state of the set of superposition states includes a non-zero contribution from a first (second) qubit state of the set of initial states. A dressed frequency difference between the first and second dressed states and a qubit frequency difference between the first and second qubit states are different. The dressing field is configured to generate first and second dressed states having a desired level of sensitivity (e.g., energy/frequency dependence) on the component of the external magnetic field that is in the quantization direction of the quantum system.

### CROSS-REFERENCE TO RELATED APPLICATIONS

This application claims priority to U.S. Application No. 63/581,017, filed Sep. 7, 2023, the content of which is incorporated herein by reference in its entirety.

### TECHNICAL FIELD

Various embodiments relate to controlling frequency dependence of 0 Gauss clock state frequency on external magnetic fields using a microwave dressing field. Various embodiments relate to a multiple qubit quantum logic gate that uses a microwave dressing field to cause target qubits to be sensitive to external magnetic fields and a non-zero magnetic field gradient to mediate entanglement of the target qubits. Various embodiments, relate to increasing coherence time of a qubit by applying a microwave dressing field resulting in superposition states that behave effectively as clock states at a non-zero magnetic field amplitude.

### BACKGROUND

For large quantum charge-coupled device (QCCD)-based quantum computers that use hyperfine splitting qubits, operating at a low magnetic field amplitude (e.g., less than 10 G) enables an acceptably uniform magnetic field to be provided through the quantum processor. Additionally, the quantum processor is operated at a magnetic field amplitude greater than 0 G to enable the energy splitting of the hyperfine states. Generally, a set of low F (e.g., F=0, 1, and/or 2), m=0 states are used to define a qubit sub-space of the qubits. However, these m=0 states only act as clock states at 0 G magnetic field amplitude. Thus, when operating in a magnetic field having an amplitude in the 2-5 G range, the m=0 states are not clock states (e.g., they have energies/frequencies that are linearly sensitive to changes in the magnetic field). This can lead to significantly increased memory errors and/or reduced memory coherence time. Through applied effort, ingenuity, and innovation many deficiencies of such conventional quantum computers have been solved by developing solutions that are structured in accordance with the embodiments of the present invention, many examples of which are described in detail herein.

### BRIEF SUMMARY OF EXAMPLE EMBODIMENTS

Example embodiments provide quantum systems, controllers of quantum systems, and corresponding methods for controlling the sensitivity of 0 Gauss clock states (e.g., hyperfine states that act as clock states at a magnetic field amplitude/magnitude of 0 Gauss) to external magnetic fields. For example, various embodiments provide QCCD-quantum computers that use hyperfine splitting qubits, controllers of QCCD-based quantum computers, and corresponding methods for controlling the sensitivity of the qubits to external magnetic fields. For example, in example embodiments, quantum systems, controllers for quantum systems, and corresponding methods are provided for controlling (e.g., decreasing) qubit sensitivity to external magnetic fields to increase the coherence time of one or more qubits. In example embodiments, quantum systems, controllers for quantum systems, and corresponding methods are provided for controlling (e.g., increasing) qubit sensitivity to external magnetic fields to perform a multiple qubit by enabling a non-zero magnetic field gradient to mediate an entanglement of two or more qubits.

In various embodiments, a qubit has an initial set of quantum states. The initial set of quantum states includes a first qubit state and a second qubit state of a qubit sub-space of the initial set of quantum states. The initial set of states is defined at least in part by hyper splitting of quantum states of the quantum object acting as the qubit. In various embodiments, controlling the sensitivity of a qubit to external magnetic fields includes causing a dressing field to be present at a target location defined at least in part by the confinement apparatus. The dressing field interacts with a qubit disposed at the target location to cause the quantum states of the qubit to be dressed and/or modified to provide a set of superposition states. Each dressed state of the set of superposition states is a superposition of two or more quantum states of the initial set of quantum states. The set of superposition states includes a first dressed state that includes a non-zero contribution from the first qubit state and a second dressed state that includes a non-zero contribution from the second qubit state.

By controlling various aspects of the dressing field (e.g., magnitude, frequency, and/or polarization), the coupling of states of the set of initial states that results in the first dressed state and the coupling of states of the set of initial states that results in the second dressed state can be controlled to provide the first dressed state and the second dressed state with desired magnetic field sensitivity. For example, in an example embodiment, various aspects of the dressing field are controlled such that the first dressed state and the second dressed state are insensitive to changes in external magnetic fields in a magnetic field operating regime of the system. In another example, in an example embodiment, various aspects of the dressing field are controlled such that the first dressed state and the second dressed state are sensitive to external magnetic fields such that a non-zero magnetic field gradient may be used to mediate entanglement and/or other interaction between two or more qubits.

According to one aspect, a method for performing a multiple qubit gate on two or more qubits confined by a confinement apparatus. In an example embodiment, the method includes controlling, by a controller, operation of a dressing field circuit to cause the dressing field circuit to generate a dressing field at a target location defined at least in part by the confinement apparatus. The dressing field is configured to modify respective energy structures of the two or more qubits disposed at the target location by causing a set of initial states of a respective qubit of the two or more qubits to form a set of superposition states. A first dressed state of the set of superposition states includes a non-zero contribution from a first qubit state of the set of initial states and a second dressed state of the set of superposition states includes a non-zero contribution from a second qubit state of the set of initial states. The first dressed state and the second dressed state are more sensitive to magnetic fields than the first qubit state and the second qubit state. A non-zero magnetic field gradient is present at the target location and mediates an entanglement of the two or more qubits disposed at the target location. The method further includes, after a gate time passes, controlling, by the controller, operation of the dressing field circuit to cause the dressing field circuit to stop generating the dressing field at the target location such that the respective energy structures of the two or more qubits revert to respective initial energy structures including the set of initial states.

In an example embodiment, the dressing field circuit stops generating the dressing field at the target location, the respective energy structures of the two or more target qubits revert to an initial energy structure including the set of initial states of the qubit.

In an example embodiment, the operation of the dressing field circuit is controlled such that when the dressing field circuit starts generating the dressing field, an amplitude of the dressing field increases from zero to a gate amplitude over a time period that is longer than a reciprocal of a frequency difference between the first dressed state and the second dressed state.

In an example embodiment, the operation of the dressing field circuit is controlled such that when the dressing field circuit stops generating the dressing field, an amplitude of the dressing field decreases from a gate amplitude to zero over a time period that is longer than a reciprocal of a frequency difference between the first dressed state and the second dressed state.

In an example embodiment, the operation of the dressing field circuit is controlled such that the dressing field is turned on and turned off adiabatically.

In an example embodiment, controlling operation of the dressing field circuit comprises controlling operation of a current source or voltage source configured to provide a respective one of current or voltage to the dressing field circuit.

In an example embodiment, the dressing field is a microwave field.

In an example embodiment, the dressing field circuit is disposed on the confinement apparatus.

In an example embodiment, the dressing field circuit is lithographically printed on a surface of the confinement apparatus.

According to another aspect, a method for performing a clock state generation procedure on one or more target qubits confined by a confinement apparatus is provided. In an example embodiment, the method includes controlling, by a controller, operation of a dressing field circuit to cause the dressing field circuit to generate a dressing field at a target location defined at least in part by the confinement apparatus. The dressing field is configured to modify respective energy structures of the one or more target qubits disposed at the target location by causing respective sets of initial states of the one or more target qubits to form respective sets of superposition states. A first dressed state of the respective sets of superposition states includes a non-zero contribution from a first qubit state of the respective sets of initial states and a second dressed state of the respective sets of superposition states includes a non-zero contribution from a second qubit state of the respective sets of initial states. A substantially uniform magnetic field has an operational magnetic field amplitude across the confinement apparatus and the first dressed state and the second dressed state behave effectively as clock states at the operational magnetic field amplitude.

In an example embodiment, the first dressed state is formed by coupling a first two or more states of the initial set of states and the second dressed state is formed by coupling a second two or more states of the initial set of states.

In an example embodiment, the coupling of the first two or more states and the coupling of the second two or more states of the initial set of states causes an AC Zeeman shift with a linear dependence on magnetic field having a same magnitude and opposite sign as an energy dependence on an external magnetic fields of the first qubit states and second qubit state.

In an example embodiment, the method further includes prior to transporting the qubit, controlling operation of the dressing field circuit to cause the dressing field circuit to stop generating the dressing field at the target location such that the energy structure of the qubit reverts to an initial energy structure including the set of initial states of the qubit.

In an example embodiment, the operation of the dressing field circuit is controlled such that when the dressing field circuit starts generating the dressing field, an amplitude of the dressing field increases from zero to a dressing amplitude over a time period that is longer than a reciprocal of a frequency difference between the first dressed state and the second dressed state.

In an example embodiment, the operation of the dressing field circuit is controlled such that the dressing field is turned on and turned off adiabatically.

In an example embodiment, controlling operation of the dressing field circuit comprises controlling operation of a current source or voltage source configured to provide a respective one of current or voltage to the dressing field circuit.

In an example embodiment, the dressing field is a microwave field.

In an example embodiment, the dressing field circuit is disposed on the confinement apparatus.

In an example embodiment, the dressing field circuit is lithographically printed on a surface of the confinement apparatus.

In an example embodiment, the method further includes controlling, by the controller, operation of one or more manipulation sources to generate and provide respective manipulation signals such that the respective manipulation signals are incident on the one or more target qubits located at the target location; the respective manipulation signals cause a single qubit gate or a multiple qubit gate to be performed on the one or more target qubits; and at least one of the respective frequencies of the respective manipulation signals or the frequency difference between the respective manipulation signals corresponds to a frequency difference between the first dressed state and the second dressed state.

In an example embodiment, the clock state generation procedure is performed to elongate a qubit coherence time of the one or more target qubits.

According to another aspect, a system configured to perform a multiple qubit gate on two or more target qubits is provided. In an example embodiment, the system includes a confinement apparatus configured to confine a plurality of qubits, the plurality of qubits including the two or more target qubits; a dressing field circuit, the dressing field circuit and the confinement apparatus defining, at least in part, a target location; a magnetic field source configured to generate a non-zero magnetic field gradient at the target location; and a controller configured to control operation of the dressing field circuit. The controller is configured to control operation of the dressing field circuit to cause the multiple qubit gate to be performed on the two or more target qubits located at the target location by performing controlling operation of a dressing field circuit to cause the dressing field circuit to generate a dressing field at a target location defined at least in part by the confinement apparatus. The dressing field is configured to modify respective energy structures of the two or more qubits disposed at the target location by causing a set of initial states of a respective qubit of the two or more qubits to form a set of superposition states. A first dressed state of the set of superposition states includes a non-zero contribution from a first qubit state of the set of initial states and a second dressed state of the set of superposition states includes a non-zero contribution from a second qubit state of the set of initial states. The first dressed state and the second dressed state are more sensitive to magnetic fields than the first qubit state and the second qubit state. A non-zero magnetic field gradient is present at the target location and mediates an entanglement of the two or more qubits disposed at the target location. The controller is further configured to perform, after a gate time passes, controlling operation of the dressing field circuit to cause the dressing field circuit to stop generating the dressing field at the target location such that the respective energy structures of the two or more qubits revert to respective initial energy structures including the set of initial states.

In an example embodiment, when the dressing field circuit stops generating the dressing field at the target location, the respective energy structures of the two or more target qubits revert to an initial energy structure including the set of initial states of the qubit.

In an example embodiment, the operation of the dressing field circuit is controlled such that when the dressing field circuit starts generating the dressing field, an amplitude of the dressing field increases from zero to a gate amplitude over a time period that is longer than a reciprocal of a frequency difference between the first dressed state and the second dressed state.

In an example embodiment, the operation of the dressing field circuit is controlled such that when the dressing field circuit stops generating the dressing field, an amplitude of the dressing field decreases from a gate amplitude to zero over a time period that is longer than a reciprocal of a frequency difference between the first dressed state and the second dressed state.

In an example embodiment, the operation of the dressing field circuit is controlled such that the dressing field is turned on and turned off adiabatically.

In an example embodiment, controlling operation of the dressing field circuit comprises controlling operation of a current source or voltage source configured to provide a respective one of current or voltage to the dressing field circuit.

In an example embodiment, the dressing field is a microwave field.

In an example embodiment, the dressing field circuit is disposed on the confinement apparatus.

In an example embodiment, the dressing field circuit is lithographically printed on a surface of the confinement apparatus.

According to another aspect, a system configured to perform a clock state generation procedure on one or more target qubits is provided. In an example embodiment, the system includes a confinement apparatus configured to confine a plurality of qubits, the plurality of qubits including the two or more target qubits; a dressing field circuit, the dressing field circuit and the confinement apparatus defining, at least in part, a target location; and a controller configured to control operation of the dressing field circuit. The controller is configured to control operation of the dressing field circuit to cause the clock state generation procedure to be performed on the one or more target qubits located at the target location by performing controlling operation of a dressing field circuit to cause the dressing field circuit to generate a dressing field at a target location defined at least in part by the confinement apparatus. The dressing field is configured to modify respective energy structures of the one or more target qubits disposed at the target location by causing respective sets of initial states of the one or more target qubits to form respective sets of superposition states. A first dressed state of the respective sets of superposition states includes a non-zero contribution from a first qubit state of the respective sets of initial states and a second dressed state of the respective sets of superposition states includes a non-zero contribution from a second qubit state of the respective sets of initial states. A substantially uniform magnetic field has an operational magnetic field amplitude across the confinement apparatus and the first dressed state and the second dressed state behave effectively as clock states at the operational magnetic field amplitude.

In an example embodiment, the first dressed state is formed by coupling a first two or more states of the initial set of states and the second dressed state is formed by coupling a second two or more states of the initial set of states.

In an example embodiment, the coupling of the first two or more states and the coupling of the second two or more states of the initial set of states causes an AC Zeeman shift with a linear dependence on magnetic field having a same magnitude and opposite sign as an energy dependence on an external magnetic fields of the first qubit states and second qubit state.

In an example embodiment, the operation of the dressing field circuit is controlled such that when the dressing field circuit starts generating the dressing field, an amplitude of the dressing field increases from zero to a dressing amplitude over a time period that is longer than a reciprocal of a frequency difference between the first dressed state and the second dressed state.

In an example embodiment, the operation of the dressing field circuit is controlled such that when the dressing field circuit stops generating the dressing field, an amplitude of the dressing field decreases from a dressing amplitude to zero over a time period that is longer than a reciprocal of a frequency difference between the first dressed state and the second dressed state.

In an example embodiment, the operation of the dressing field circuit is controlled such that the dressing field is turned on and turned off adiabatically.

In an example embodiment, controlling operation of the dressing field circuit comprises controlling operation of a current source or voltage source configured to provide a respective one of current or voltage to the dressing field circuit.

In an example embodiment, the dressing field is a microwave field.

In an example embodiment, wherein the dressing field circuit is disposed on the confinement apparatus.

In an example embodiment, the dressing field circuit is lithographically printed on a surface of the confinement apparatus.

In an example embodiment, controller is further configured to perform controlling operation of one or more manipulation sources to generate and provide respective manipulation signals such that the respective manipulation signals are incident on the one or more target qubits located at the target location; the respective manipulation signals cause a single qubit gate or a multiple qubit gate to be performed on the one or more target qubits; and at least one of the respective frequencies of the respective manipulation signals or the frequency difference between the respective manipulation signals corresponds to a frequency difference between the first dressed state and the second dressed state.

In an example embodiment, the clock state generation procedure is performed to elongate a qubit coherence time of the one or more target qubits.

According to another aspect, a controller configured to control one or more components of a quantum system and configured to cause the quantum system to perform a multiple qubit gate is provided. In an example embodiment, the controller comprises a processing device, memory storing executable instructions, and driver controller elements. The executable instructions are configured to, when executed by the processing device, cause the controller to use the driver controller elements to control operation of a dressing field circuit to cause the dressing field circuit to generate a dressing field at a target location defined at least in part by the confinement apparatus. The dressing field is configured to modify respective energy structures of the two or more qubits disposed at the target location by causing a set of initial states of a respective qubit of the two or more qubits to form a set of superposition states. A first dressed state of the set of superposition states includes a non-zero contribution from a first qubit state of the set of initial states and a second dressed state of the set of superposition states includes a non-zero contribution from a second qubit state of the set of initial states. The first dressed state and the second dressed state being more sensitive to magnetic fields than the first qubit state and the second qubit state. A non-zero magnetic field gradient is present at the target location and mediates an entanglement of the two or more qubits disposed at the target location. The executable instructions are configured to, when executed by the processing device, cause the controller to use the driver controller elements to, after a gate time passes, control operation of the dressing field circuit to cause the dressing field circuit to stop generating the dressing field at the target location such that the respective energy structures of the two or more qubits revert to respective initial energy structures including the set of initial states.

According to yet another aspect, a controller configured to control one or more components of a quantum system and configured to cause the quantum system to perform a clock state generation procedure is provided. The controller comprises a processing device, memory storing executable instructions, and driver controller elements. The executable instructions are configured to, when executed by the processing device, cause the controller to use the driver controller elements to control operation of a dressing field circuit to cause the dressing field circuit to generate a dressing field at a target location defined at least in part by the confinement apparatus. The dressing field is configured to modify respective energy structures of the one or more target qubits disposed at the target location by causing respective sets of initial states of the one or more target qubits to form respective sets of superposition states. A first dressed state of the respective sets of superposition states includes a non-zero contribution from a first qubit state of the respective sets of initial states and a second dressed state of the respective sets of superposition states includes a non-zero contribution from a second qubit state of the respective sets of initial states. A substantially uniform magnetic field has an operational magnetic field amplitude across the confinement apparatus and the first dressed state and the second dressed state behave effectively as clock states at the operational magnetic field amplitude.

According to still another aspect, a computer program product is provided. The computer program product comprises a non-transitory computer storage medium storing computer executable instructions. The computer executable instructions are configured, when executed by a processing device of a controller, to cause the controller to use driver controller elements thereof to control operation of a dressing field circuit to cause the dressing field circuit to generate a dressing field at a target location defined at least in part by the confinement apparatus. The dressing field is configured to modify respective energy structures of the two or more qubits disposed at the target location by causing a set of initial states of a respective qubit of the two or more qubits to form a set of superposition states. A first dressed state of the set of superposition states includes a non-zero contribution from a first qubit state of the set of initial states and a second dressed state of the set of superposition states includes a non-zero contribution from a second qubit state of the set of initial states. The first dressed state and the second dressed state being more sensitive to magnetic fields than the first qubit state and the second qubit state. A non-zero magnetic field gradient is present at the target location and mediates an entanglement of the two or more qubits disposed at the target location. The executable instructions are configured to, when executed by the processing device, cause the controller to use the driver controller elements to, after a gate time passes, control operation of the dressing field circuit to cause the dressing field circuit to stop generating the dressing field at the target location such that the respective energy structures of the two or more qubits revert to respective initial energy structures including the set of initial states.

According to still another aspect, a computer program product is provided. The computer program product comprises a non-transitory computer storage medium storing computer executable instructions. The computer executable instructions are configured, when executed by a processing device of a controller, to cause the controller to use driver controller elements thereof to control operation of a dressing field circuit to cause the dressing field circuit to generate a dressing field at a target location defined at least in part by the confinement apparatus. The dressing field is configured to modify respective energy structures of the one or more target qubits disposed at the target location by causing respective sets of initial states of the one or more target qubits to form respective sets of superposition states. A first dressed state of the respective sets of superposition states includes a non-zero contribution from a first qubit state of the respective sets of initial states and a second dressed state of the respective sets of superposition states includes a non-zero contribution from a second qubit state of the respective sets of initial states. A substantially uniform magnetic field has an operational magnetic field amplitude across the confinement apparatus and the first dressed state and the second dressed state behave effectively as clock states at the operational magnetic field amplitude.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 provides a block diagram of an example quantum charge-coupled device (QCCD)-based quantum system, in accordance with an example embodiment.

FIG. 2 provides a schematic diagram of a top view of an example confinement region of a confinement apparatus that includes a target location, in accordance with an example embodiment.

FIG. 3 provides a schematic diagram of an example set of initial states and an example set of superposition states, in accordance with an example embodiment.

FIG. 4A provides flowchart illustrating processes and/or operations for performing a multiple qubit gate, in accordance with an example embodiment.

FIG. 4B provides a diagram illustrating the amplitude or intensity of a dressing field and qubit sensitivity to magnetic fields over time during performance of a multiple qubit gate, in accordance with an example embodiment.

FIG. 5A provides flowchart illustrating processes and/or operations for performing a clock state generation procedure, in accordance with an example embodiment.

FIG. 5B provides a diagram illustrating the amplitude or intensity of a dressing field and qubit sensitivity to magnetic fields over time during performance of a clock state generation procedure, in accordance with an example embodiment.

FIG. 6 provides a schematic diagram of an example controller of a quantum system, in accordance with an example embodiment.

FIG. 7 provides a schematic diagram of an example computing entity of a quantum system that may be used in accordance with an example embodiment.

### DETAILED DESCRIPTION OF SOME EXAMPLE EMBODIMENTS

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally” and “approximately” refer to within appropriate engineering and/or manufacturing limits and/or within user measurement capabilities, unless otherwise indicated. Like numbers refer to like elements throughout.

Example embodiments provide quantum systems, controllers of quantum systems, and corresponding methods for controlling the sensitivity of 0 Gauss clock states (e.g., hyperfine states that act as clock states at a magnetic field amplitude/magnitude of 0 Gauss) to external magnetic fields. For example, various embodiments, provide QCCD-quantum computers that use hyperfine splitting qubits, controllers of QCCD-based quantum computers, and corresponding methods for controlling the sensitivity of the qubits to external magnetic fields.

In various embodiments, quantum objects having hyperfine splitting levels are used as qubits of a QCCD-based quantum computer. Hyperfine splitting levels are the result of the nuclear magnetic dipole moment of the quantum object (e.g., an ion in an example embodiment) interacting with the magnetic field generated by the electrons of the quantum object and the nuclear electric quadrupole moment of the quantum object interacting with the electric field gradient cause by the distribution of charge within the quantum object.

Pairs of hyperfine splitting levels are clock states at respective magnetic field amplitude/magnitude. For example, at 0 Gauss, the F=2, m=0 and F=1, m=0 states of singly ionized Ba 137 are clock states. Clock states are states that have the same energy/frequency dependence on an external magnetic field (in particular, the external magnetic field in the quantization direction of qubits) at a particular magnetic field amplitude/magnitude. For example, the energy difference between two clock states is constant at a particular magnetic field amplitude/magnitude for small changes or perturbations in the magnetic field. The term external magnetic field is used to identify a magnetic field that is independent of the qubit and/or quantum object. While the hyperfine structure of Ba 137 is used as an example herein, various embodiments may use a various nuclear spin greater than zero ions as quantum objects, as appropriate for the application.

As should be understood, the magnetic quantum number m specifies the component of orbital angular momentum of a quantum object, like an atom or ion, that lies along a given axes. The given axis is aligned with and/or defines the quantization direction of the qubits and is generally referred to as the z-axis in the qubit's reference frame.

In example embodiments, quantum systems, controllers for quantum systems, and corresponding methods are provided for controlling qubit sensitivity to external magnetic fields to increase the coherence time of one or more qubits.

In example embodiments, quantum systems, controllers for quantum systems, and corresponding methods are provided for controlling qubit sensitivity to external magnetic fields to perform a multiple qubit gate by enabling a non-zero magnetic field gradient to mediate an entanglement of two or more qubits.

In various embodiments, a qubit has an initial set of quantum states. The initial set of quantum states includes a first qubit state and a second qubit state of a qubit sub-space of the initial set of quantum states. The initial set of states is defined at least in part by hyper splitting of quantum states of the quantum object acting as the qubit. In various embodiments, controlling the sensitivity of a qubit to external magnetic fields includes causing a dressing field to be present at a target location defined at least in part by the confinement apparatus. The dressing field interacts with a qubit disposed at the target location to cause the quantum states of the qubit to be dressed and/or modified to provide a set of superposition states. Each dressed state of the set of superposition states is a superposition of two or more quantum states of the initial set of quantum states. The set of superposition states includes a first dressed state that includes a non-zero contribution from the first qubit state and a second dressed state that includes a non-zero contribution from the second qubit state.

By controlling various aspects of the dressing field (e.g., magnitude, frequency, and/or polarization), the coupling of states of the set of initial states that results in the first dressed state and the coupling of states of the set of initial states that results in the second dressed state can be controlled to provide the first dressed state and the second dressed state with desired magnetic field sensitivity.

For example, in an example embodiment, various aspects of the dressing field are controlled such that the first dressed state and the second dressed state are insensitive to changes in external magnetic fields in a magnetic field operating regime of the system.

In another example, in an example embodiment, various aspects of the dressing field are controlled such that the first dressed state and the second dressed state are sensitive to external magnetic fields such that a non-zero magnetic field gradient may be used to mediate entanglement and/or other interaction between two or more qubits.

From the perspective of the one or more target qubits located at the target location, the dressing field is turned on and off slowly such that the respective energy structures of the one or more target qubits are dressed and/or modified from the set of initial states to the set of superposition states adiabatically. As used herein, the term “slowly” relates to the dressing field being turned on and/or turned off at a time scale that is slow compared to the frequency difference between the first dressed state and the second dressed state and/or the frequency difference between the first qubit state and the second qubit state. For example, the time that elapses while the dressing field is turned on from a zero-amplitude to a set amplitude (e.g., a dressing amplitude and/or a gate amplitude) and the time that elapses while the dressing field is turned off from the set amplitude (e.g., the dressing amplitude and/or the gate amplitude) to a zero-amplitude are each longer than one over the frequency difference between the first dressed state and the second dressed state (e.g., greater than the reciprocal of the frequency difference between the first dressed state and the second dressed state) and/or one over the frequency difference between the first qubit state and the second qubit state (e.g., greater than the reciprocal of the frequency difference between the first qubit state and the second qubit state).

For large quantum charge-coupled device (QCCD)-based quantum computers that use hyperfine splitting qubits, operating at a low magnetic field amplitude (e.g., less than 10 G) enables a uniform magnetic field to be provided through the quantum processor. Additionally, the quantum processor is operated at a magnetic field amplitude greater than 0 G to enable the energy splitting of the hyperfine states. Generally, a set of low F (e.g., F=0, 1, and/or 2), m=0 states are used to define a qubit sub-space of the qubits. However, these m=0 states only act as clock states at 0 G magnetic field amplitude. Thus, when operating in with a magnetic field having an amplitude in the 2-5 G range, the m=0 states are not clock states (e.g., they have energies/frequencies that are sensitive to changes in the magnetic field). This leads to conventional QCCD-based quantum computers using hyper splitting qubits to experience memory errors and/or reduced memory coherence time. Therefore, technical problems exist regarding elongating the coherence time of hyper splitting qubits of QCCD-based quantum computers.

Various embodiments provide technical solutions to these technical problems. For example, various embodiments provide for controlling the sensitivity of a qubit to an external magnetic field. For example, in various embodiments, a dressing field is generated at a target location. The dressing field causes an energy structure of a qubit located at the target location to be modified such that a set of initial states of the qubit located at the target location is caused to form a set of superposition states. The set of super position states include a first dressed state of the set of superposition states includes a non-zero contribution from a first qubit state of the set of initial states and a second dressed state of the set of superposition states includes a non-zero contribution from a second qubit state of the set of initial states. The first dressed state and the second dressed state behave effectively as clock states at the operating magnetic field amplitude/magnitude of the system. As the first dressed state and the second dressed state behave effectively as clock states, the coherence time of the qubit is effectively infinite while the qubit is in the first dressed state and/or the second dressed state. Therefore, various embodiments provide for elongating qubit coherence time, which reduces memory errors and enables performance of deeper quantum circuits. Therefore, various embodiments provide improvements over conventional QCCD-based quantum computers.

Moreover, performance of conventional quantum logic gates requires radiating fields such as laser beams, microwaves, and/or the like to enact, mediate, and/or cause the entanglement of qubits. However, these radiating fields may lead to various gate errors such as photon scattering and/or affecting transitions in spectator qubits, which can lead to crosstalk problems, phase noise, and/or the like. These gate errors can lead to low fidelity logic gates and noisy computations. Moreover, quantum logic gates that use radiating fields are highly sensitive to the state of one or more motional modes of the qubits. Therefore, spin-motion coupling can lead to additional gate errors and/or a significant amount of time is needed to cool the qubits to close to their motional ground states prior to performance of a quantum logic gate. Thus, various technical problems exist regarding the performance of quantum logic gates.

On possible technical solution to these technical problems is the use of non-zero magnetic field gradients to enact, mediate and/or cause the entanglement of qubits. However, for such an interaction to be performed in a reasonable amount of time, this would require the qubits to be sensitive to magnetic fields. Conventionally, causing qubits to be sensitive to magnetic fields includes performing a shelving process where the qubit states of the qubit are shelved to states outside of the qubit sub-space that are sensitive to magnetic fields. However, this shelving is performed by driving the transition from the qubit states to the shelved states with lasers, which can lead to crosstalk problems, phase noise, and/or the like. Therefore, technical problems exit regarding the performance of quantum logic gates.

Various embodiments provide technical solutions to these technical problems. In particular, rather than shelving the qubits to enable a non-zero magnetic field gradient to enact, mediate, and/or cause the entanglement of two or more qubits, a dressing field may be applied to the two or more qubits. The dressing field causes the respective energy structures of qubits located at the target location to be modified such that respective sets of initial states of the qubits located at the target location is caused to form respective sets of superposition states. The set of superposition states include a first dressed state of the set of superposition states that includes a non-zero contribution from a first qubit state of the set of initial states and a second dressed state of the set of superposition states that includes a non-zero contribution from a second qubit state of the set of initial states. The first dressed state and the second dressed state are more sensitive to external magnetic fields than the qubit states. A non-zero magnetic field gradient present at the target location may then enact, mediate, and/or cause the entanglement of the two or more qubits. Therefore, various embodiments provide for performance of multiple qubits gates without the use of lasers and various errors (such as crosstalk, phase noise, and/or the like) that may be introduced by the use of lasers in such a system. Therefore, various embodiments provide improvements over conventional QCCD-based quantum computers.

### Example QCCD-Based Quantum System

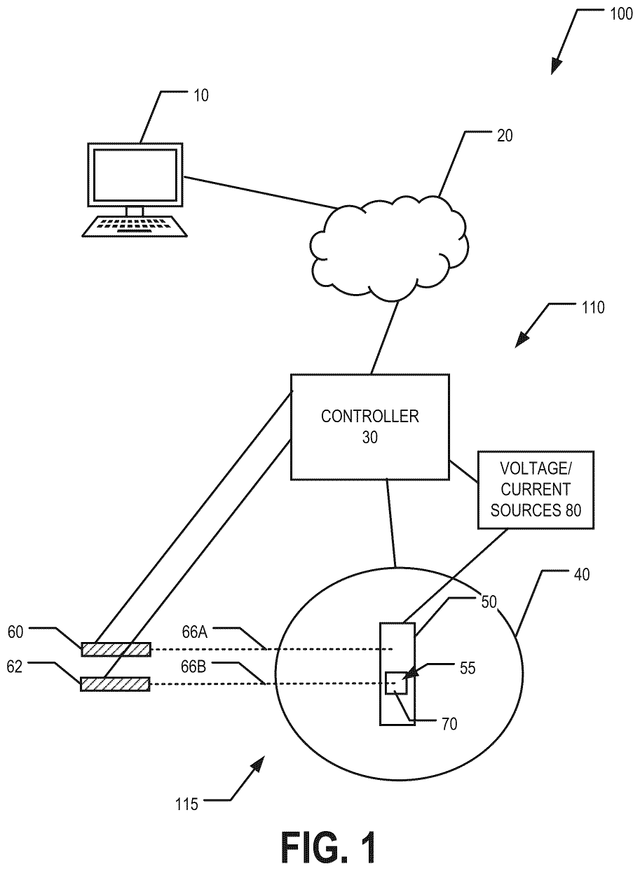

An example system that may be configured to perform qubit magnetic field sensitivity control in accordance with various embodiments is a quantum charge-coupled device (QCCD)-based quantum system using hyperfine splitting qubits. FIG. 1 provides a schematic diagram of an example QCCD-based quantum system 100 that can be used to perform qubit magnetic field sensitivity control in accordance with various embodiments. The example QCCD-based quantum system 100 shown in FIG. 1 is a quantum computer system comprising a confinement apparatus 50 defining, at least in part, at least one target location 55. For example, the confinement apparatus 50 is configured to confine one or more qubits. In an example embodiment, the confinement apparatus 50 is an ion trap (e.g., a surface ion trap and/or a Paul trap) and the qubits are ions. In various embodiments, the confinement apparatus 50 comprises or is physically associated a dressing field circuit 70 that is operable to generate a dressing field at the target location 55.

In various embodiments, the dressing field circuit 70 is a circuit (e.g., a printed circuit) that is part of the confinement apparatus 50 (e.g., disposed and/or embedded in the same substrate and/or chip as the confinement apparatus 50) or disposed in physical proximity to the confinement apparatus 50 such that qubits disposed and/or confined at the target location 55 experience the dressing field when the dressing field circuit 70 is operated. For example, the dressing field circuit 70 is lithographically printed on the confinement apparatus 50, in an example embodiment. In various embodiments, the dressing field is a microwave field.

In various embodiments, the confinement apparatus 50 is configured to confine qubits in one or more confinement regions defined by the confinement apparatus 50. In various embodiments, a qubit is and/or is embodied as a neutral or charged atom; a neutral, charged, or multipole molecule; quantum particle; quantum dot; or other object that is able to be confined by the confinement apparatus and having an energy structure that is manipulatable via one or more dressing fields. For example, in an example embodiment, the confinement apparatus 50 is an ion trap (e.g., surface ion trap and/or Paul ion trap) and the qubits are ions with a non-zero nuclear spin.

In various embodiments, the QCCD-based quantum system 100 comprises a computing entity 10 and a quantum computer 110. In various embodiments, the quantum computer 110 comprises a controller 30 and a quantum processor 115. In various embodiments, the quantum processor 115 comprises a cryogenic and/or vacuum chamber 40 enclosing a confinement apparatus 50 and an associated dressing field circuit 70, one or more manipulation sources (e.g., laser 60, microwave source 62), and a magnetic field source 90. In an example embodiment, the one or more manipulation sources comprise one or more optical sources such as lasers 60, one or more microwave sources 62, and/or the like.

In various embodiments, the one or more lasers 60 are configured to generate and/or provide manipulation signals (e.g., optical beams) configured to manipulate and/or cause a controlled quantum state evolution of one or more quantum objects confined by the confinement apparatus 50. In various embodiments, the one or more microwave sources 62 are configured to generate and/or provide gate microwave signals configured to cause performance of single qubit gates on a target qubit that has a dressed and/or modified energy structure (e.g., an energy structure comprising a set of superposition states that includes a first dressed state and a second dressed state). For example, in an example embodiment, the one or more manipulation sources configured to provide manipulation signals (e.g., optical/laser beams in the case of lasers 60 and/or microwave gate signals in the case of microwave sources 62) to respective target locations defined at least in part by the confinement apparatus 50 within the cryogenic and/or vacuum chamber 40 via respective beam delivery systems 66 (e.g., 66A, 66B). In various embodiments, a beam delivery system 66 comprises one or more optical elements, photonic integrated circuits (PICs), optical fibers, free space optical elements, waveguides, and/or the like. In an example embodiment, the microwave source 62 is a circuit formed on a substrate housing the confinement apparatus 50 and/or on another substrate disposed within the cryogenic and/or vacuum chamber 40 and mounted to and/or secured in relation to the confinement apparatus 50. For example, in an example embodiment, a microwave source 62 is an integrated circuit configured for carrying GHz frequency alternating current (AC) currents.

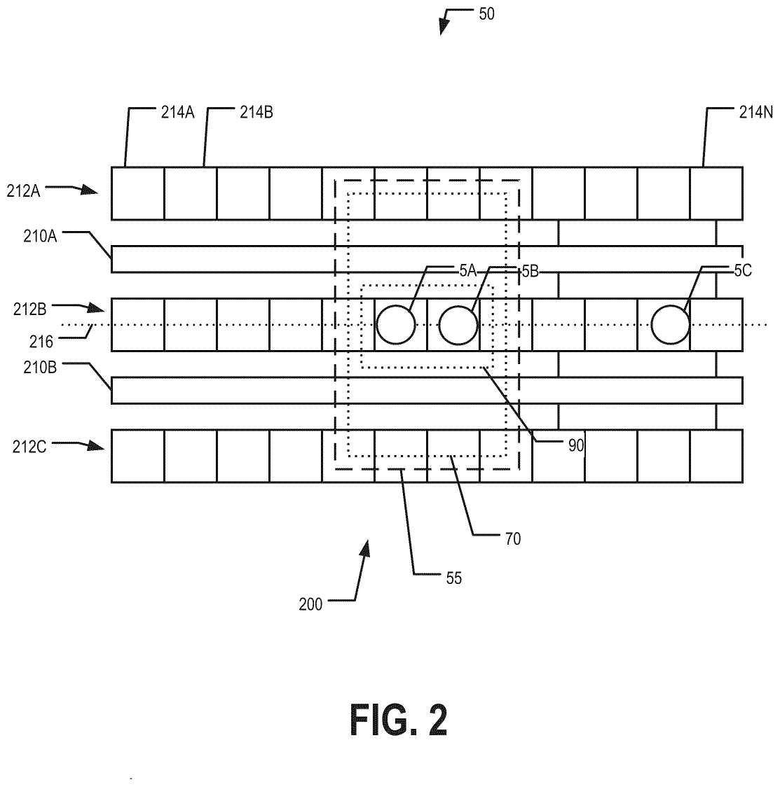

In various embodiments, the quantum processor 115 includes one or more magnetic field sources 90 (see FIG. 2). In various embodiments, the magnetic field sources 90 may be permanent magnets (e.g., made of ferromagnetic material) and/or electromagnets. The one or more magnetic field sources 90 may be secured to the substrate that houses the confinement apparatus 50 and/or otherwise mounted within the cryogenic and/or vacuum chamber 40. For example, the magnetic field sources 90 may be similar to those described by U.S. Application No. 63/509,098, filed Jun. 20, 2023, the content of which is incorporated herein by reference in its entirety. In various embodiments, the one or more magnetic field sources 90 are configured to generate non-zero magnetic field gradients at respective target locations 55 of the confinement apparatus 50 (e.g., respective target locations configured for performance of multiple qubit gates thereat). In an example embodiment, a target location 55 configured for performance of a clock state generation procedure, may not have a magnetic field source 90 disposed thereat.

In various embodiments, the quantum processor 115 further comprises a plurality of voltage and/or current sources 80. The voltage and/or current sources 80 are operable (e.g., by the controller 30) to generate and provide voltage signals or current signals to electrical elements (e.g., electrodes) of the confinement apparatus 50, one or more dressing field circuits 70, one or more magnetic field sources 90 (in instances where the one or more magnetic field sources 90 are electromagnets), and/or the like.

In various embodiments, a computing entity 10 is configured to allow a user to provide input to the quantum computer 110 (e.g., via a user interface of the computing entity 10) and receive, view, and/or the like output from the quantum computer 110. The computing entity 10 may be in communication with the controller 30 of the quantum computer 110 via one or more wired or wireless networks 20 and/or via direct wired and/or wireless communications. In an example embodiment, the computing entity 10 may translate, configure, format, and/or the like information/data, quantum computing algorithms, and/or the like into a computing language, executable instructions, command sets, and/or the like that the controller 30 can understand and/or implement.

In various embodiments, the controller 30 is configured to control the voltage and/or current sources 80, cryogenic system and/or vacuum system controlling the temperature and pressure within the cryogenic and/or vacuum chamber 40, manipulation sources (e.g., lasers 60, microwave sources 62, and/or the like), and/or other systems controlling the environmental conditions (e.g., temperature, humidity, pressure, and/or the like) within the cryogenic and/or vacuum chamber 40 and/or configured to manipulate and/or cause a controlled evolution of quantum states of one or more qubits confined by the confinement apparatus 50 (e.g., magnetic field sources 90 in embodiments where the magnetic field sources include electromagnets).

FIG. 2 illustrates a top view of a portion of a confinement apparatus 50. The illustrated portion of the confinement apparatus 50 includes radio frequency (RF) rails 210A, 210B and three sequences of control electrodes 212A, 212B, 212C. Each sequence of control electrodes 212 comprises a plurality of control electrodes 214. For example, the illustrated portion of the sequence of control electrodes 212A includes control electrodes 214A, 214B, . . . 214N.

In various embodiments, RF voltage sources of the voltage and/or current sources 80 generate and provide an RF voltage signal that is applied to the RF rails 210A, 210B to generate a pseudopotential that defines one or more linear confinement regions 200 of the confinement apparatus 50. The null point of the pseudopotential generated by the RF voltage signals being applied to the RF rails 210A, 210B defines the RF null axis 216 that extends substantially along a center line of the linear confinement region 200. The quantum objects confined by the confinement apparatus 50 are confined in the one or more linear confinement regions 200.

In various embodiments, the confinement apparatus 50 and the dressing field circuit 70 define a target location 55. When a qubit is confined by the confinement apparatus 50 within the target location 55 (and the dressing field circuit 70 is being operated to generate a dressing field), the qubit experiences a dressing field. In various embodiments, the dressing field is a microwave field (e.g., oscillates with a frequency in the range of 100 MHz to 500 GHz).

In various embodiments, the dressing field circuit 70 is a circuit (e.g., a printed circuit) that is part of the confinement apparatus 50 (e.g., disposed and/or embedded in the same substrate and/or chip as the confinement apparatus 50) or disposed in physical proximity to the confinement apparatus 50 such that qubits disposed and/or confined at the target location 55 experience the dressing field when the dressing field circuit 70 is operated. For example, the dressing field circuit 70 is lithographically printed on the confinement apparatus 50, in an example embodiment. In various embodiments, the controller 30 is configured to control operation of the dressing field circuit 70 by controlling operation of a voltage and/or current source 80 configured to provide a voltage signal and/or current signal to the dressing field circuit 70.

In various embodiments, the dressing field circuit 70 is configured to generate a dressing field that is a microwave field having a polarization that is in a plane that is perpendicular to quantization field of the confinement apparatus 50. The quantization field of the confinement apparatus 50 defines the quantization direction for the qubits confined by the confinement apparatus 50. In various embodiments, the quantization field is a substantially static magnetic field that is generally uniform across the confinement apparatus 50. In an example embodiment, the quantization field is into or out of the page of FIG. 2 and the polarization of the dressing field is in the plane of the page of FIG. 2.

In various embodiments, the dressing field circuit 70 is configured to generate a dressing field having an amplitude that decays significantly and/or quickly outside of the target location 55. For example, the dressing field circuit 70 is configured to generate a dressing field that decays and/or decreases outside of the target location 55 such that the dressing field only causes trackable AC Zeeman shifts on one or more additional qubits confined by the confinement apparatus and disposed outside of the target location. The trackable AC Zeeman shifts may be accounted for by the quantum system 100 such that they do not lead to errors or gate infidelity.

For example, target qubits 5A, 5B disposed and/or confined at the target location 55 experience a dressing field (e.g., while the dressing field circuit 70 is being operated) that causes the respective energy structures of the target qubits 5A, 5B to be modified and/or dressed to include a respective set of superposition states. An additional qubit 5C is disposed and/or confined outside of the target location 55. The additional qubit 5C has an energy structure that includes a set of initial sets. For example, the energy structure of the additional qubit 5C is not dressed and/or modified to include a set of superposition states. The additional qubit 5C may experience an AC Zeeman shift that is trackable and/or calculable. For example, the AC Zeeman shift experienced by the additional qubit 5C can be determined and tracked (e.g., by controller 30) such that the AC Zeeman shift experienced by the additional qubit 5C is tracked and/or accounted for by the quantum system 100. For example, the AC Zeeman shift experienced by the additional qubit 5C is tracked and/or accounted for such that the AC Zeeman shift experienced by the additional qubit 5C does not cause errors within a computation and/or controlled quantum state evolution performed by the quantum system 100. For example, the trackable AC Zeeman shift may cause the phase of the additional qubit 5C to evolve at a different rate than it would if the additional qubit 5C had been located further away from the target location 55 and/or if the dressing field had not been turned on.

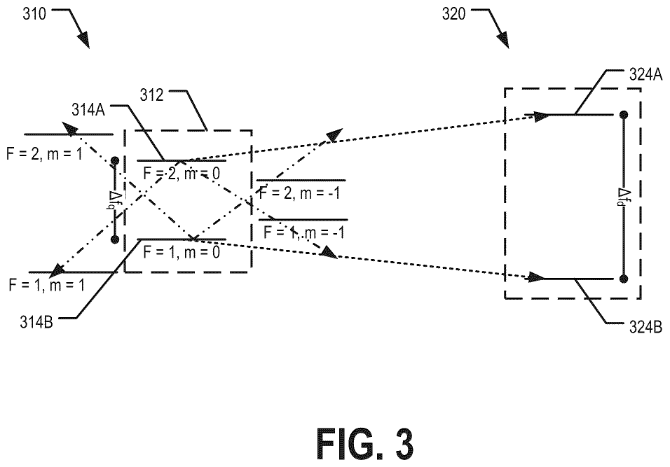

FIG. 3 illustrates at least a portion of a set of initial states 310 of a qubit. The set of initial states 310 includes a qubit sub-space 312 of the energy structure of the qubit. The qubit sub-space 312 includes a first qubit state 314A and a second qubit state 314B. The energy difference between the first qubit state 314A and the second qubit state 314B corresponds to a qubit frequency difference Δf_{q}. For example, the energy difference ΔE_{q} between the first qubit state 314A and the second qubit state 314B is equal to the qubit frequency difference Δf_{q} multiplied by Planck's constant h (e.g., ΔE_{q}=h Δf_{q}).

In the illustrated embodiment, corresponding to the example use of singly ionized Ba 137 as the qubits 5, the set of initial states 310 includes the F=2, m=1; F=2, m=0; F=2, m=−1; F=1, m=1; F=1, m=0; F=1, m=−1 states. The qubit sub-space 312 includes the F=2, m=0 and F=1, m=0 states. For example, in the illustrated embodiment, the first qubit state 314A is the F=2, m=0 state and the second qubit state 314B is the F=1, m=0 state. In various other embodiments where various other quantum objects are used as qubits, various other sets of initial states are present with corresponding selection of the qubit sub-space and the first and second qubit states, as appropriate for the application. In the illustrated embodiment, the dressing field, illustrated by the dash-double-dot lines, couples the first qubit state 314A (e.g., the F=2, m=0 state) with one or more states that are sensitive to magnetic fields (e.g., the F=1, m=+/−1 states) and couples the second qubit state 314B (e.g., the F=1, m=0 state) with one or more different states that are sensitive to magnetic fields (e.g., the F=2, m=+/−1 states).

FIG. 3 also illustrates at least a portion of a set of superposition states 320. The set of superposition states 320 comprises at least two dressed states that are superpositions of respective states of the set of initial states 310. For example, a dressed state Ψ_{d} is formed by a combination and/or contributed to by multiple initial states Ψᵢ of the set of initial states 310 (e.g., Ψ_{d}=α^{j}Ψᵢ^{j} for coefficients α and initial states Ψᵢ indexed by j and using Einstein summation notation).

The set of superposition states 320 includes a first dressed state 324A. The first dressed state 324A includes a non-zero contribution from the first qubit state 314A. For example, the coefficient α corresponding to the first qubit state 314A in a mathematical representation of the first dressed state 324A is non-zero. In an example embodiment, the first dressed state 324A does not include a contribution from the second qubit state 314B. For example, the coefficient α corresponding to the second qubit state 314B in a mathematical representation of the first dressed state 324A is zero. In the illustrated example embodiment, the first dressed state 324A includes non-zero contributions from the F=1, m+/−1 states of the initial set of states 310 and the F=2, m=0 state (e.g., the first qubit state 314A).

The set of superposition states 320 further includes a second dressed state 324B. The second dressed state 324B includes a non-zero contribution from the second qubit state 314B. For example, the coefficient α corresponding to the second qubit state 314B in a mathematical representation of the second dressed state 324B is non-zero. In an example embodiment, the second dressed state 324B does not include a contribution from the first qubit state 314A. For example, the coefficient α corresponding to the first qubit state 314A in a mathematical representation of the second dressed state 324B is zero. In the illustrated example embodiment, the second dressed state 324B includes non-zero contributions from the F=2, m+/−1 states of the initial set of states 310 and the F=1, m=0 state (e.g., the second qubit state 314B).

Notably, the first dressed state 324A and the second dressed state 324B include non-zero contributions from different and/or non-overlapping groups of states from the set of initial states 310.

The energy difference between the first dressed state 324A and the second dressed state 324B corresponds to a dressed frequency difference Δf_{d}. For example, the energy difference ΔE_{d} between the first dressed state 324A and the second dressed state 324B is equal to the dressed frequency difference Δf_{d} multiplied by Planck's constant h (e.g., ΔE_{d}=h Δf_{d}).

In various embodiments, the dressed frequency difference Δf_{d} is different from the qubit frequency difference Δf_{q}. For example, the difference between the dressed frequency difference Δf_{d} and the qubit frequency difference Δf_{q} is in a range of 0.1 to 20 MHz, in various embodiments (e.g., 0.1 MHz≤Δf_{d}−Δf_{q}|≤20 MHz).

Due to the contribution of quantum states having non-zero magnetic quantum numbers m to the first dressed state 324A and the second dressed state 324B, the first dressed state 324A and the second dressed state 324B have different sensitivities to external magnetic fields than the first qubit state 314A and the second qubit state 314B. For example, the coupling of multiple states from the set of initial states 310 to form a respective dressed state results in the dressed state having properties that are a hybrid of and/or influenced by each of the coupled states. The coupling of various states of the set of initial states 310 may therefore be tuned to generate dressed states having desired properties, such as desired dependencies on external magnetic fields (e.g., at least the component of an external magnetic field aligned with the quantization axis of the confinement apparatus 50).

For example, based on the desired properties of the dressed states and the known properties of the set of initial states 310, a desired coupling may be determined that would provide the desired properties of the dressed states. The dressing field circuit 70 is then engineered and/or designed to be operable to generate a dressing field that enacts the desired coupling.

For example, in various embodiments, the first dressed state 324A and the second dressed state 324B may be more sensitive to external magnetic fields than the first qubit state 314A and the second qubit state 314B. For example, in an example embodiment, a small change in the external magnetic field may cause a larger change in the respective energies/frequencies of the first dressed state 324A and the second dressed state 324B compared to the first qubit state 314A and the second qubit state 314B. In another example, in an example embodiment, a small change in the external magnetic field may cause a larger change in the dressed frequency difference Δf_{d} between the first dressed state 324A and the second dressed state 324B compared to the qubit frequency different Δf_{q} between the first qubit state 314A and the second qubit state 314B. For example, the couplings of the set of initial states 310 that results in the first dressed state 324A and the second dressed state 324B may be tuned such that the first dressed state 324A and the second dressed state 324B are sufficiently sensitive to external magnetic fields (and/or components of external magnetic fields that are aligned with the quantization direction of the confinement apparatus 50) that a non-zero magnetic field gradient can enact, mediate, and/or cause an entanglement of two or more qubits disposed within the target location 55 in a set amount of time (e.g., a gate time).

In another example, in various embodiments, the first dressed state 324A and the second dressed state 324B may be less sensitive to external magnetic fields than the first qubit state 314A and the second qubit state 314B. For example, in an example embodiment, a small change in the external magnetic field may cause a smaller change in the respective energies/frequencies of the first dressed state 324A and the second dressed state 324B compared to the first qubit state 314A and the second qubit state 314B. In another example, in an example embodiment, a small change in the external magnetic field may cause a smaller change in the dressed frequency difference Δf_{d} between the first dressed state 324A and the second dressed state 324B compared to the qubit frequency different Δf_{q} between the first qubit state 314A and the second qubit state 314B.

For example, in an example embodiment, the first qubit state 314A and the second qubit state 314B, which are almost clock states, have a particular energy dependence on external magnetic fields at the operational magnetic field amplitude/magnitude of the quantum system 100. The dressing field is tuned so that the coupling of states of the set of initial states 310 results in an AC Zeeman shift that has a linear dependence on the component of the external magnetic field in the quantization direction of the same magnitude but opposite sign as the energy dependence on external magnetic fields of the qubits states. This causes the resulting first dressed state 324A and second dressed state 324B caused by the coupling introduced by the dressing field to behave effectively as clock states at the non-zero operational magnetic field amplitude/magnitude with which the quantum system 100 (e.g., a QCCD-based quantum computer) is operated. In other words, the dressing field is tuned such that respective energies/frequencies of the first dressed state 324A and the second dressed state 324B have the same dependence on changes to (the component in the quantization direction) of the external magnetic field. This results in the dressed frequency difference Δf_{d} being constant even when the target qubit experiences small changes (e.g., noise and/or perturbations) in the external magnetic field.

The qubits confined by the confinement apparatus 50 may be transported between different locations of the confinement apparatus 50 through the application of sets of voltage signal sequences (e.g., generated by voltage and/or current sources 80) to the control electrodes 212. For example, a qubit (or multiple qubits) may be transported into and/or out of a target location 55 and/or other locations defined by the confinement apparatus 50. For example, the controller 30 is configured to control the voltage and/or current sources 80 to cause performance of a transport operation on a qubit (or group of qubits) between various locations defined by the confinement apparatus 50.

In an example embodiment, the confinement apparatus 50 comprises and/or defines a single linear confinement region 200. In various embodiments, the confinement apparatus 50 comprises and/or defines a plurality and/or an array of linear confinement regions 200. For example, in an example embodiment, the confinement apparatus 50 comprises and/or defines a two-dimensional array of linear confinement regions 200.

### Example Operation of a Quantum System to Perform a Multiple Qubit Gate

In various systems, a quantum system, such as the QCCD-based quantum system 100 is operable to perform a single qubit gate. In various embodiments, performing the single qubit gate includes modifying and/or dressing the energy structure of a target qubit by adiabatically applying a dressing field to the target qubit and applying a gate microwave signal to the target qubit that is tuned and/or resonant with a dressed frequency difference corresponding to the modified and/or dressed energy structure of the target qubit.

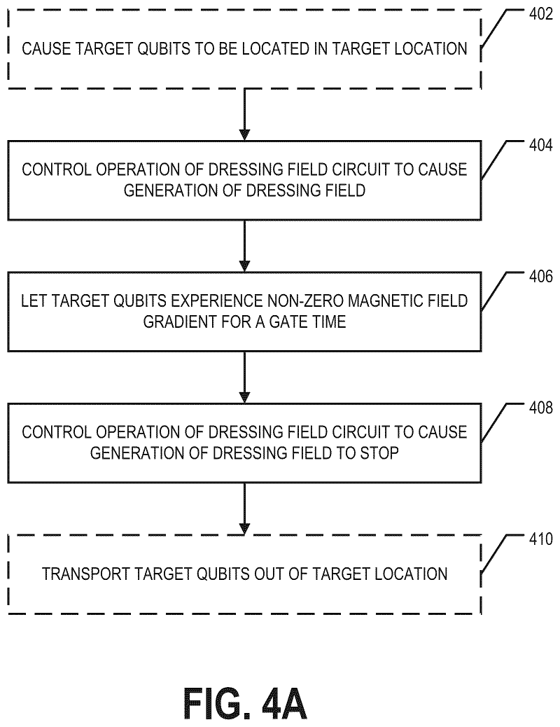

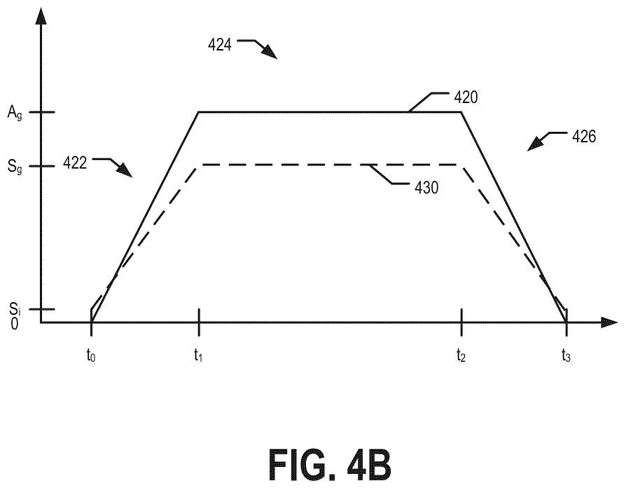

FIG. 4A provides a flowchart of processes, procedures, operations, and/or the like performed by a controller 30 of a quantum system 100 to perform a multiple qubit gate, in accordance with an example embodiment. In various embodiments, a multiple qubit gate is performed as part of performing a quantum circuit and/or algorithm. For example, a multiple qubit gate may be performed to entangle two or more qubits.

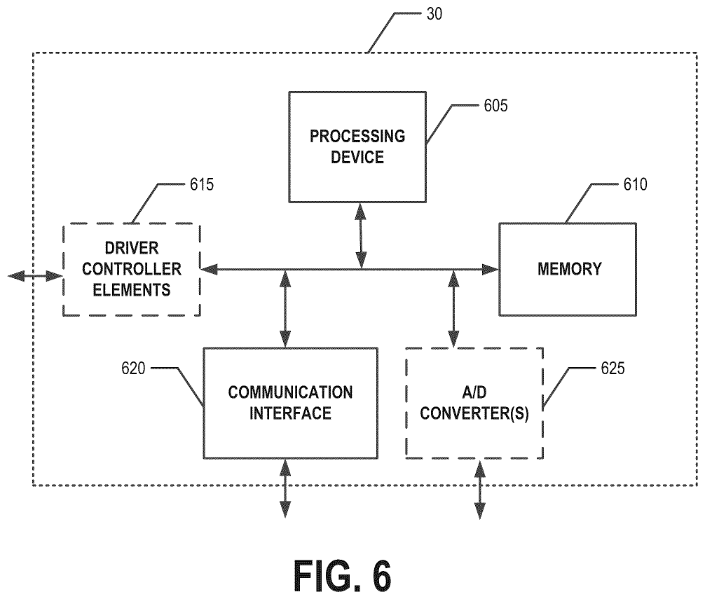

In various embodiments, the qubits 5 (e.g., 5A, 5B, 5C) confined by the confinement apparatus 50 can be transported between various locations defined by the confinement apparatus 50. For example, a qubit 5 can be transported into or out of a target location 55. In various embodiments, starting at step 402, the controller 30 causes two or more target qubits 5A, 5B that are to be entangled via performance of a multiple qubit gate be located within the target location 55. For example, in an instance where one or more of the target qubits 5A, 5B are located outside of the target location 55, the controller 30 controls operation of one or more voltage and/or current sources 80 (e.g., via one or more driver controller elements 615, see FIG. 6) to cause the target qubits 5A, 5B to be transported into the target location 55. In an instance where at least one of the target qubits 5A, 5B is located within the target location 55, the controller 30 controls operation of one or more voltage and/or current sources (e.g., via one or more driver controller elements 615, see FIG. 6) to cause the at least one of the target qubits 5A, 5B to continue to be located in the target location 55.

At step 404, while the target qubits 5A, 5B are disposed, located, and/or confined within the target location 55, the controller 30 controls operation of the dressing field circuit 70 to cause generation of a dressing field at the target location 55. For example, the controller 30 controls operation of one or more voltage and/or current sources 80 (e.g., via one or more driver controller elements 615) to cause the one or more voltage and/or current sources 80 to provide a voltage signal and/or current signal to the dressing field circuit 70 to cause the dressing field circuit to generate a dressing field. For example, in an example embodiment, the controller 30 controls operation of one or more voltage and/or current sources 80 (e.g., via one or more driver controller elements 615) to cause the one or more voltage and/or current sources 80 to provide an increasing (e.g., from zero amplitude toward a target non-zero amplitude) voltage signal and/or current signal to the dressing field circuit 70.

From the perspective of the target qubits 5A, 5B, the dressing field is turned on slowly such that the respective energy structures of the target qubits are dressed and/or modified from the respective set of initial states 310 to the set of superposition states 320 adiabatically. As used herein, the term “slowly” relates to the dressing field being turned on (for performance of the multiple qubit gate) at a time scale that is slow compared to the qubit frequency difference and/or the dressed frequency difference. For example, the time that elapses while the dressing field is turned on from a zero-amplitude to a gate amplitude is longer than one over the dressed frequency difference (e.g., greater than the reciprocal of the dressed frequency difference Δf_{d}) and/or longer than one over the qubit frequency different (e.g., greater than the reciprocal of the qubit frequency difference Δf_{q}).

For example, FIG. 4B provides a plot illustrating the evolution of the amplitude of the dressing field 420 with respect to time during performance of the multiple qubit gate. FIG. 4B also illustrates the sensitivity 430 of the target qubits 5A, 5B to (components in the quantization direction) of external magnetic fields with respect to time during performance of the multiple qubit gate.

For example, at an initial time to the amplitude of the dressing field is zero. During a turn on time period 422 extending from the initial time t₀ to a first time t₁ (t₀<t₁) the amplitude of the dressing field increases from zero to the gate amplitude A_{g}. In the illustrated embodiment, the increase in amplitude of the dressing field is linear over the turn on time period 422. Various other functional forms may be used for increasing the amplitude of the dressing field in a monotonically increasing fashion starting at the initial time to until the first time t₁.

In various embodiments, the turn on time period is longer than the reciprocal of the dressed frequency difference (e.g., t₁−t₀>1/Δf_{d}) and/or longer than the reciprocal of the qubit frequency difference (e.g., t₁−t₀>1/Δf_{q}). The slow turn on and/or increase in amplitude of the dressing field causes the respective energy structures of the target qubits 5A, 5B to be dressed and/or modified adiabatically such that quantum information stored by the target qubits 5A, 5B is maintained (e.g., not destroyed) by the turning on of the dressing field.

As the amplitude of the dressing field is (slowly) increased, the strength of the couplings caused by the dressing field increases. As the first dressed state 324A and the second dressed state 324B are more sensitive to magnetic fields than the first qubit state 314A and the second qubit state 314B, the increasing amplitude of the dressing field causes the target qubits 5A, 5B to be become more sensitive to at least the component in the quantization direction of external magnetic fields. For example, at the initial time, the target qubits 5A, 5B have an initial sensitivity level Sᵢ to a component of the external magnetic fields that is in the quantization direction. At the first time t₁, the target qubits 5A, 5B have a gate sensitivity level S_{g} to a component of the external magnetic fields that is in the quantization direction.

In various embodiments, the sensitivity of the target qubits 5A, 5B to the component of the external magnetic fields that is in the quantization direction corresponds to the derivative of the energy level of the target qubits 5A, 5B with respect to the component of the external magnetic fields that is in the quantization direction. In an example embodiment, the sensitivity of the target qubits 5A, 5B to the component of the external magnetic fields that is in the quantization direction corresponds to the derivative of the energy difference between a first state of the instantaneous energy structure of a qubit that has a non-zero contribution from the first qubit state 314A and a second state of the instantaneous energy structure of a qubit that has a non-zero contribution from the second qubit state 314B. For example, the initial sensitivity (e.g., sensitivity at the initial time to) of the target qubits to the component of the external magnetic field that is in the quantization direction is the derivative of qubit frequency difference with respect to the component of the external magnetic field that is in the quantization direction and the gate sensitivity (e.g., sensitivity at the first time t₁) of the target qubits to the component of the external magnetic field that is in the quantization direction is the derivative of dressed frequency difference with respect to the component of the external magnetic field that is in the quantization direction.

At step 406, the controller 30 allows the target qubits 5A, 5B experience a non-zero magnetic field gradient that is present at the target location 55 between the first time t₁ and a second time t₂. The time between the first time t₁ and the second time t₂ is a gate time period 424 configured to provide the two or more target qubits 5A, 5B sufficient time to interact (as mediated by the non-zero magnetic field gradient present at the target location 55) to cause the entanglement of the two or more target qubits 5A, 5B. For example, the temporal length of the gate time period 424 (e.g., t₂−t₁) is determined based at least in part on an amount of time it takes for the non-zero magnetic field gradient to mediate/enact/cause the entanglement of the two or more target qubits located at the target location 55 give then sensitivity of the first dressed state 324A and the second dressed state 324B to external magnetic fields (and/or components thereof in the quantization direction).

In an example embodiment, the magnetic field gradient has an amplitude/magnitude of greater than 100 T/m and the gate time period is less than 10⁴ μs. In an example embodiment, the magnetic field gradient has an amplitude/magnitude of greater than 200 T/m and the gate time period is less than 3×10³ μs. In an example embodiment, the magnetic field gradient has an amplitude/magnitude of greater than 300 T/m and the gate time period is less than 10³ μs. For example, in various embodiments, the gate time period is determined at least in part based on a function of the amplitude/magnitude of the magnetic field gradient, the sensitivity of the target qubits to external magnetic fields, and/or the like, and/or the like.

In an example embodiment, the magnetic field source 90 may be a permanent magnet (e.g., comprise ferromagnetic material) and the controller 30 may run a timer to ensure the target qubits 5A, 5B experience a non-zero magnetic field gradient generated by the magnetic field source 90 for a gate time period 424. In another example, the magnetic field source 90 may be an electromagnet and the controller 30 may (e.g., via a driver controller element 615) cause a voltage and/or current source 80 to provide an appropriate voltage and/or current signal to the electromagnet to cause the electromagnet to generate the non-zero magnetic field gradient at least for the duration of the gate time period 424. In an example embodiment where the magnetic field source 90 is an electromagnet, the controller 30 may also run a timer to ensure the target qubits 5A, 5B experience a non-zero magnetic field gradient generated by the magnetic field source 90 for a gate time period 424.

In an example embodiment, the non-zero magnetic field gradient is a static magnetic field gradient and is generally constant during the gate time period 424. In an example embodiment, the magnetic field gradient is an oscillating magnetic field gradient that oscillates with a frequency that is less than the motional frequency of one or more motional modes of the target qubits 5A, 5B. For example, the magnetic field gradient may oscillate such that a spin-motion coupling of the target qubits is reduced and/or eliminated via interaction of the target qubits with the magnetic field gradient during the performance of the multiple qubit gate.

In response to the controller 30 determining that the target qubits 5A, 5B have experienced the non-zero magnetic field gradient for a gate time period 424, the process continues to step 408. For example, responsive to determining that the time has reached the second time t₂, the controller 30 continues to step 408.

At step 408, the controller 30 controls operation of the dressing field circuit 70 to cause generation of a dressing field at the target location 55 to stop. For example, the controller 30 controls operation of one or more voltage and/or current sources 80 (e.g., via one or more driver controller elements 615) to cause the one or more voltage and/or current sources 80 to provide a voltage signal and/or current signal to the dressing field circuit 70 that causes the dressing field circuit 70 to stop generating the dressing field. For example, in an example embodiment, the controller 30 controls operation of one or more voltage and/or current sources 80 (e.g., via one or more driver controller elements 615) to cause the one or more voltage and/or current sources 80 to provide a decreasing (e.g., from a previous amplitude toward zero amplitude) voltage signal and/or current signal to the dressing field circuit 70.

From the perspective of the two or more target qubits 5A, 5B, the dressing field is turned off slowly such that the respective energy structures of the target qubits are undressed and/or returned to the former energy structure adiabatically. For example, the energy structure of each target qubit is undressed and/or modified such that the set of superposition states are adiabatically returned to the set of initial states. As used herein, the term “slowly” relates to the dressing field being turned off (after performance of the multiple qubit gate) at a time scale that is slow compared to the dressed frequency difference Δf_{d} and/or the qubit frequency difference Δf_{q}. For example, the time that elapses while the dressing field is turned off from the gate amplitude A_{q} to a zero amplitude is longer than one over the dressed frequency difference (e.g., greater than the reciprocal of the dressed frequency difference) and/or longer than one over the qubit frequency difference (e.g., greater than the reciprocal of the qubit frequency difference).

For example, at a second time t₂ (t₁<t₂) the amplitude of the dressing field is the gate amplitude A_{g}. During a turn off time period 426 extending from the second time t₂ to a third time t₃ (t₂<t₃) the amplitude of the dressing field decreases from the gate amplitude A_{g} to zero. In the illustrated embodiment, the decrease in amplitude of the dressing field is linear over the turn off time period 426. Various other functional forms may be used for decreasing the amplitude of the dressing field in a monotonically decreasing fashion starting at the second time t₂ until the third time t₃.

In various embodiments, the turn off time period is longer than the reciprocal of the dressed frequency difference (e.g., t₃−t₂>1/Δf_{d}) and/or longer than the reciprocal of the qubit frequency difference (e.g., t₃−t₂>1/Δf_{q}). The slow turn off and/or decrease in amplitude of the dressing field causes the respective energy structures of the target qubits 5A, 5B to be undressed and/or modified adiabatically such that quantum information stored by the respective target qubits 5A, 5B is maintained (e.g., not destroyed) by the turning off of the dressing field.

As the amplitude of the dressing field is (slowly) decreased, the strength of the couplings caused by the dressing field decreases. As the first qubit state 314A and the second qubit state 314B are less sensitive to magnetic fields than the first dressed state 324A and the second dressed state 324B, the decreasing amplitude of the dressing field causes the target qubits 5A, 5B to be become less sensitive to external magnetic fields (at least the component thereof in the quantization direction). For example, at the second time t₂, the target qubits 5A, 5B have a gate sensitivity level S_{g} to a component of the external magnetic field that is in the quantization direction. At the third time t₃, the target qubits 5A, 5B have an initial sensitivity level Sᵢ to a component of the external magnetic field that is in the quantization direction (Sᵢ<S_{g}).

In various embodiments, controller 30 determines information regarding AC Zeeman shifts imparted to one or more additional qubits 5C located and/or disposed outside of the target location 55 as a result of the dressing field being generated at the target location 55 (e.g., between the initial time to and the third time t₃). For example, while the amplitude of the dressing field decays quickly with distance from the target location 55, an additional qubit 5C located and/or disposed outside of the target location 55 may experience the dressing field at low amplitude/intensity. For example, the additional qubit 5C located and/or disposed outside of the target location 55 does not experience the dressing field at sufficiently high amplitude/intensity for the energy structure of the additional qubit 5C to be dressed and/or modified in the same manner as the target qubits 5A, 5B. Moreover, the non-zero magnetic field gradient decays quickly with distance from the target location 55. Thus, the additional qubit 5C does not experience interaction with any neighboring additional qubits in the manner that the target qubits 5A, 5B located within the target location 55. Thus, the additional qubit 5C is not affected by the dressing field beyond a trackable AC Zeeman shift.

The low amplitude/intensity dressing field experienced by the additional qubit 5C causes the additional qubit 5C to experience an AC Zeeman shift. An AC Zeeman shift is the magnetic counterpart or version of an AC Stark shift. In particular, the oscillating magnetic field of the dressing field interacting with the additional qubit 5C can change the speed or rate with which the additional qubit 5C accumulates phase. As such, a phase accumulator corresponding to the additional qubit 5C and stored in a classical memory (e.g., memory 610, see FIG. 6) of the controller 30 may be updated based on the AC Zeeman shift experienced by the additional qubit 5C.

For example, the classical memory 610 of the controller 30 may store a phase accumulator corresponding to each qubit confined by the confinement apparatus 50. The phase accumulator corresponding to a respective qubit may be periodically, regularly, and/or constantly updated or updated in a triggered manner to reflect the phase accumulated by the respective qubit. In various embodiments, the memory 610 stores executable instructions for calculating and/or determining information corresponding to an AC Zeeman shift experienced by a respective qubit based on the respective qubit's distance from the target location 55 (which controls the amplitude/intensity of the dressing field experienced by the respective qubit), the gate time period (e.g., the elapsed time between the first time t₁ and the second time t₂) or the time elapsed between the initial time and the third time (e.g., t₃−t₀), and/or other information corresponding to the AC Zeeman shift experienced by the respective qubit. In an example embodiment, the memory 610 stores executable instructions for using the information regarding the AC Zeeman shift experienced by the respective qubit for updating the phase accumulator corresponding to the respective qubit. A processing device 605 of the controller 30 executes the executable instructions to cause the controller to determine information corresponding to respective AC Zeeman shifts imparted to one or more additional qubits, store the information corresponding to the respective AC Zeeman shifts imparted to the one or more additional qubits, update the phase accumulators corresponding to the one or more additional qubits based on the information corresponding to the respective AC Zeeman shifts imparted to the one or more additional qubits, and/or the like, in various embodiments.

In various embodiments, the phase accumulators corresponding to respective qubits may be used to perform one or more quantum error correction tasks corresponding to the respective qubits, adjust and/or control the phase of one or more laser beams caused to be incident on the respective qubits, and/or the like.

At step 410, the controller 30 may cause at least one of the two or more target qubits 5A, 5B to be transported out of the target location 55. For example, the controller 30 controls operation of one or more voltage and/or current sources 80 (e.g., via one or more driver controller elements 615) to cause at least one of the target qubits 5A, 5B to be transported out of the target location 55. In an instance where at least one of the target qubits 5A, 5B is to remain in the target location 55 (e.g., to be gated and/or interact with a different target qubit), the controller 30 controls operation of one or more voltage and/or current sources (e.g., via one or more driver controller elements 615) to cause the at least one of the target qubits 5A, 5B to continue to be located in the target location 55.

### Example Operation of a Quantum System to Perform a Clock State Generation Procedure

In various systems, a quantum system, such as the QCCD-based quantum system 100 is operable to perform a clock state generation procedure. In various embodiments, performing the clock state generation procedure includes modifying and/or dressing the respective energy structures of one or more target qubits by adiabatically applying a dressing field to the one or more target qubits. The one or more target qubits are located at a target location 55 that may be a storage location configured for storing qubits. For example, the target location may be a storage and/or sorting section such as described by U.S. Application No. 63/504,808, filed May 30, 2023, the content of which is incorporated herein by reference. In another example, the target location may be a cache confinement site and/or a storage area as described by U.S. Application No. 63/476,226, filed Dec. 20, 2022, the content of which is incorporated herein by reference. In another example, the target location may be a quantum operation location/section (e.g., a region of the confinement apparatus where single and/or multiple qubit gates and/or qubit reading operations are performed), a gate zone (e.g., a region of the confinement apparatus where single and/or multiple qubit gates are performed), along a data bus confinement corridor, and/or the like.

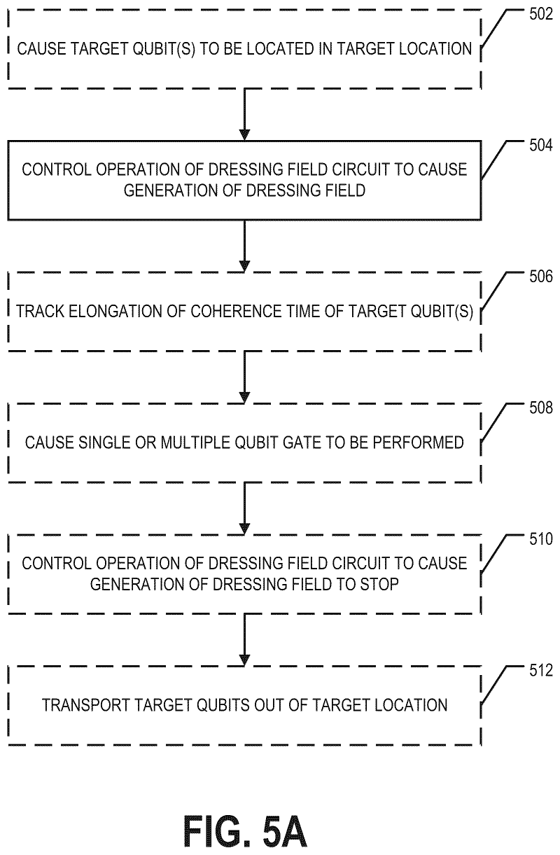

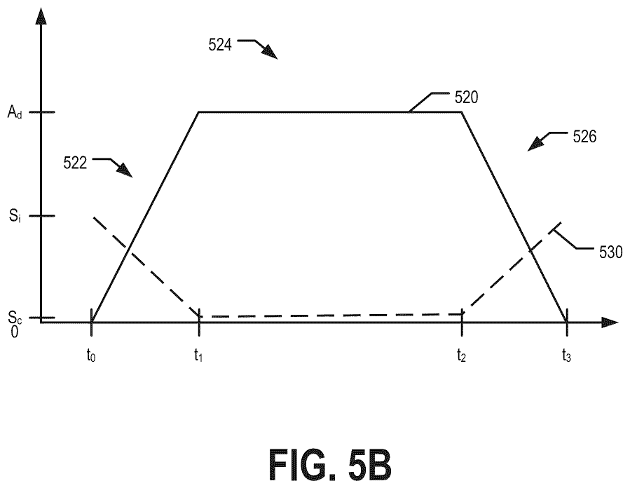

FIG. 5A provides a flowchart of processes, procedures, operations, and/or the like performed by a controller 30 of a quantum system 100 to perform a clock state generation procedure, in accordance with an example embodiment. In various embodiments, a clock state generation procedure is performed as part of performing a quantum circuit and/or algorithm. For example, if a qubit is to be stored for a period of time during performance of a quantum circuit and/or algorithm (e.g., the quantum information stored by the qubit will be needed at some point in the future, but not currently), a clock state generation procedure may be performed on the qubit to cause the quantum information to be retained by the qubit for an extended length of time. For example, the clock state generation procedure may be used to elongate and/or lengthen the coherence time of a target qubit. In another example, a clock state generation procedure may be performed on one or more target qubits that are the subjects of a single qubit gate and/or a multiple qubit gate (e.g., using one or more laser beams to enact, mediate, and/or cause the performance of the gate). For example, the clock state generation procedure may be used to cause a known and stable frequency difference between the first dressed state and the second dressed state such that noise and/or fluctuations in the external magnetic field (e.g., in a component of the external magnetic field that is in the quantization direction) do not negatively affect the gate fidelity of the performed gate.

In various embodiments, the qubits 5 (e.g., 5A, 5B, 5C) confined by the confinement apparatus 50 can be transported between various locations defined by the confinement apparatus 50. For example, a qubit 5 can be transported into or out of a target location 55. In various embodiments, starting at step 502, the controller 30 causes a target qubit 5A for the clock state generation procedure to be located within the target location 55. For example, in an instance where the target qubit 5A is located outside of the target location 55, the controller 30 controls operation of one or more voltage and/or current sources 80 (e.g., via one or more driver controller elements 615) to cause the target qubit 5A to be transported into the target location 55. In an instance where the target qubit 5A is located within the target location 55, the controller 30 controls operation of one or more voltage and/or current sources (e.g., via one or more driver controller elements 615) to cause the target qubit 5A to continue to be located in the target location 55.

At step 504, while the target qubit 5A is disposed, located, and/or confined within the target location 55, the controller 30 controls operation of the dressing field circuit 70 to cause generation of a dressing field at the target location 55. For example, the controller 30 controls operation of one or more voltage and/or current sources 80 (e.g., via one or more driver controller elements 615) to cause the one or more voltage and/or current sources 80 to provide a voltage signal and/or current signal to the dressing field circuit 70 to cause the dressing field circuit to generate a dressing field. For example, in an example embodiment, the controller 30 controls operation of one or more voltage and/or current sources 80 (e.g., via one or more driver controller elements 615) to cause the one or more voltage and/or current sources 80 to provide an increasing (e.g., from zero amplitude toward a target non-zero amplitude) voltage signal and/or current signal to the dressing field circuit 70.

As noted above, the first qubit state 314A and the second qubit state 314B are almost clock states at the operation magnetic field amplitude/magnitude of the quantum system 100 (e.g., greater than 0 G and less than 10 G). Thus, the qubit frequency difference Δf_{q} is dependent on external magnetic fields at the operational magnetic field amplitude/magnitude of the quantum system 100. In other words, the derivative of the energy of the first qubit state E_{q1} with respect to the magnitude/amplitude of the component of the external magnetic field in the quantization direction is a first function of the magnitude/amplitude of the component of the external magnetic field in the quantization direction (e.g., δE_{q1}/δB_{z}=F₁(B_{z}), where the first function F₁ depends on the (initial and/or unmodified) energy structure of the qubit). The derivative of the energy of the second qubit state E_{q2} with respect to the magnitude/amplitude of the component of the external magnetic field in the quantization direction is a second function of the magnitude/amplitude of the component of the external magnetic field in the quantization direction (e.g., δE_{q2}/δB_{z}=F₂(B_{z}), where the second function F₂ depends on the (initial and/or unmodified) energy structure of the qubit). The first function F₁ and the second function F₂ are not the same, such that E_{q1}−E_{q2}=hΔf_{q} is not constant with changes and/or fluctuations in the component of the external magnetic field in the quantization direction B_{z}.

The dressing field is tuned so that the coupling of states of the set of initial states 310 results in an AC Zeeman shift that has a linear dependence on the component of the external magnetic field in the quantization direction B_{z} of the same magnitude but opposite sign as the energy dependence on external magnetic fields of the qubits states. For example, the coupling of states of the set of initial states 310 results in the derivative of the energy difference between the first dressed state 324A and the second dressed state 324B ΔE_{d} with respect to the component of the external magnetic field in the quantization direction being, at least to a first order in the component of the external magnetic field in the quantization direction approximation, to be zero. For example, at least to a first order approximation δΔE_{d}/δB_{z}=hδΔf_{d}/δB_{z}=[F₁(B_{z})−F₂(B_{z})]−[F₁(B_{z})−F₂(B_{z})]≈0. This causes the resulting first dressed state 324A and second dressed state 324B generated by the coupling introduced by the dressing field to behave effectively as clock states at the non-zero operational magnetic field amplitude/magnitude with which the quantum system 100 (e.g., a QCCD-based quantum computer) is operated.

In other words, the dressing field is tuned such that respective energies/frequencies of the first dressed state 324A and the second dressed state 324B have the same dependence on changes to (the component in the quantization direction) of the external magnetic field. This results in the dressed frequency difference Δf_{d} being constant even when a target qubit experiences small changes (e.g., noise and/or perturbations) in the external magnetic field.

From the perspective of the one or more target qubits 5A, 5B, the dressing field is turned on slowly such that the respective energy structure of the one or more target qubits is dressed and/or modified from the respective set of initial states to the respective set of superposition states adiabatically. As used herein, the term “slowly” relates to the dressing field being turned on (for performance of the clock state generation procedure) at a time scale that is slow compared to the dressed frequency difference and/or the qubit frequency difference. For example, the time that elapses while the dressing field is turned on from a zero-amplitude to a dressing amplitude is longer than one over the dressed frequency difference (e.g., greater than the reciprocal of the dressed frequency difference) and/or one over the qubit frequency difference (e.g., greater than the reciprocal of the qubit frequency difference).

For example, FIG. 5B provides a plot illustrating the evolution of the amplitude of the dressing field 520 with respect to time during performance of the clock state generation procedure. FIG. 5B also illustrates the sensitivity 530 of the one or more target qubits 5A, 5B to (components in the quantization direction) of external magnetic fields with respect to time during performance of the clock state generation procedure.

For example, at an initial time to the amplitude of the dressing field is zero. During a turn on time period 522 extending from the initial time to t₀ a first time t₁ (t₀<t₁) the amplitude of the dressing field increases from zero to the dressing amplitude A_{d}. In the illustrated embodiment, the increase in amplitude of the dressing field is linear over the turn on time period 522. Various other functional forms may be used for increasing the amplitude of the dressing field in a monotonically increasing fashion starting at the initial time to until the first time t₁.

In various embodiments, the turn on time period is longer than the reciprocal of the dressed frequency difference (e.g., t₁−t₀>1/Δf_{d}) and/or the reciprocal of the qubit frequency difference (e.g., t₁−t₀>1/Δf_{q}). The slow turn on and/or increase in amplitude of the dressing field causes the respective energy structure of the one or more target qubits 5A, 5B to be dressed and/or modified adiabatically such that quantum information stored by the one or more target qubits 5A, 5B is maintained (e.g., not destroyed) by the turning on of the dressing field.

As the amplitude of the dressing field is (slowly) increased, the strength of the couplings caused by the dressing field increases. As the first dressed state 324A and the second dressed state 324B are less sensitive to magnetic fields than the first qubit state 314A and the second qubit state 314B, the increasing amplitude of the dressing field causes the target qubits 5A, 5B to be become less sensitive to at least the component of the external magnetic field in the quantization direction. For example, at the initial time, the one or more target qubits 5A, 5B have an initial sensitivity level Sᵢ to a component of the external magnetic fields that is in the quantization direction. At the first time t₁, the one or more target qubits 5A, 5B have a clock state sensitivity level S_{c} to a component of the external magnetic fields that is in the quantization direction (Sᵢ>S_{c}).

In various embodiments, the dressing field is maintained at the dressing amplitude A_{d} for a clock state time period 524 (e.g., the time between the first time t₁ and a second time t₂). In various embodiments, the clock state time period 524 is used to elongate and/or lengthen the coherence time of the one or more target qubits 5A, 5B. In various embodiments, the clock state time period 524 is used for the performance of one or more single qubit gates and/or multiple qubit gates where the frequency difference between the occupied states of the qubits have a stable energy and/or frequency difference even if noise is present in the component of the external magnetic field in the quantization direction.

At step 506, the controller 30 tracks the elongation of the coherence time of the one or more target qubits 5A, 5B as a result of the one or more target qubits experiencing the clock state generation procedure. For example, there coherence time of a qubit where the qubit sub-space includes a pair of clock states is approximately infinite. Thus, in an example embodiment, the time during which the one or more target qubits 5A, 5B are experiencing the clock state generation procedure, the controller 30 suspends the accumulation of time on respective coherence time timers corresponding to the one or more target qubits 5A, 5B. In another example, in an example embodiment, the controller 30 tracks the amount of time that the one or more target qubits 5A, 5B are experiencing the clock state generation procedure such that respective coherence time timers corresponding to the one or more target qubits 5A, 5B are extended by the amount of time that the one or more target qubits experienced the clock state generation procedure.

At step 508, the controller 30 causes the quantum computer 110 to perform one or more single qubit gates and/or multiple qubit gates on the one or more target qubits 5A, 5B while the one or more target qubits 5A, 5B are experiencing the clock state generation procedure. For example, the controller 30 controls operation (e.g., via one or more driver controller elements 615) of one or more manipulation sources (e.g., lasers 60, microwave sources 62) to cause the one or more manipulation sources to generate and provide respective manipulation signals. The respective manipulation signals are provided to the target location 55 via respective beam delivery systems 66. The one or more manipulation signals are characterized by respective frequencies and/or a frequency difference tuned and/or corresponding to transitions between the first dressed state 324A and the second dressed state 324B. For example, the controller 30 causes a single qubit gate or a multiple qubit gate to be performed where the frequencies that characterize the respective manipulation signals correspond to the first dressed state 324A and the second dressed state 324B rather than the first qubit state 314A and the second qubit state 314B.

At step 510, the controller 30 controls operation of the dressing field circuit 70 to cause generation of a dressing field at the target location 55 to stop. For example, the controller 30 controls operation of one or more voltage and/or current sources 80 (e.g., via one or more driver controller elements 615) to cause the one or more voltage and/or current sources 80 to provide a voltage signal and/or current signal to the dressing field circuit 70 that causes the dressing field circuit 70 to stop generating the dressing field. For example, in an example embodiment, the controller 30 controls operation of one or more voltage and/or current sources 80 (e.g., via one or more driver controller elements 615) to cause the one or more voltage and/or current sources 80 to provide a decreasing (e.g., from a previous amplitude toward zero amplitude) voltage signal and/or current signal to the dressing field circuit 70.

From the perspective of the one or more target qubits 5A, 5B, the dressing field is turned off slowly such that the respective energy structures of the one or more target qubits are undressed and/or returned to the former energy structure adiabatically. For example, the energy structure of a target qubit is undressed and/or modified such that the set of superposition states are adiabatically returned to the set of initial states. As used herein, the term “slowly” relates to the dressing field being turned off (after performance of the clock state generation procedure) at a time scale that is slow compared to the dressed frequency difference Δf_{d} and/or the qubit frequency difference Δf_{q}. For example, the time that elapses while the dressing field is turned off from the dressing amplitude A_{d} to a zero amplitude is longer than one over the dressed frequency difference (e.g., greater than the reciprocal of the dressed frequency difference) and/or longer than one over the qubit frequency difference (e.g., greater than the reciprocal of the qubit frequency difference).

For example, at a second time t₂ (t₁<t₂) the amplitude of the dressing field is the dressing amplitude A_{d}. During a turn off time period 526 extending from the second time t₂ to a third time t₃ (t₂<t₃) the amplitude of the dressing field decreases from the dressing amplitude A_{d} to zero. In the illustrated embodiment, the decrease in amplitude of the dressing field is linear over the turn off time period 526. Various other functional forms may be used for decreasing the amplitude of the dressing field in a monotonically decreasing fashion starting at the second time t₂ until the third time t₃.

In various embodiments, the turn off time period 526 is longer than the reciprocal of the dressed frequency difference (e.g., t₃−t₂>1/Δf_{d}) and/or longer than the reciprocal of the qubit frequency difference (e.g., t₃−t₂>1/Δf_{q}). The slow turn off and/or decrease in amplitude of the dressing field causes the respective energy structures of the target qubits 5A, 5B to be undressed and/or modified adiabatically such that quantum information stored by the respective target qubits 5A, 5B is maintained (e.g., not destroyed) by the turning off of the dressing field.

As the amplitude of the dressing field is (slowly) decreased, the strength of the couplings caused by the dressing field decreases. As the first qubit state 314A and the second qubit state 314B are more sensitive to magnetic fields than the first dressed state 324A and the second dressed state 324B, the decreasing amplitude of the dressing field causes the target qubits 5A, 5B to be become more sensitive to external magnetic fields (at least the component thereof in the quantization direction). For example, at the second time t₂, the target qubits 5A, 5B have a clock state sensitivity level S_{c} to a component of the external magnetic field that is in the quantization direction. At the third time t₃, the target qubits 5A, 5B have an initial sensitivity level Sᵢ to a component of the external magnetic field that is in the quantization direction (S_{c}<Sᵢ).

In various embodiments, controller 30 determines information regarding AC Zeeman shifts imparted to one or more additional qubits 5C located and/or disposed outside of the target location 55 as a result of the dressing field being generated at the target location 55 (e.g., between the initial time to and the third time t). For example, while the amplitude of the dressing field decays quickly with distance from the target location 55, an additional qubit 5C located and/or disposed outside of the target location 55 may experience the dressing field at low amplitude/intensity. For example, the additional qubit 5C located and/or disposed outside of the target location 55 does not experience the dressing field at sufficiently high amplitude/intensity for the energy structure of the additional qubit 5C to be dressed and/or modified in the same manner as the target qubits 5A, 5B. Thus, the additional qubit 5C is not affected by the dressing field (and likely not affected by any gates performed during the clock state time period 524) beyond a trackable AC Zeeman shift.

The low amplitude/intensity dressing field experienced by the additional qubit 5C causes the additional qubit 5C to experience an AC Zeeman shift. An AC Zeeman shift is the magnetic counterpart or version of an AC Stark shift. In particular, the oscillating magnetic field of the dressing field interacting with the additional qubit 5C can change the speed or rate with which the additional qubit 5C accumulates phase. As such, a phase accumulator corresponding to the additional qubit 5C and stored in a classical memory (e.g., memory 610, see FIG. 6) of the controller 30 may be updated based on the AC Zeeman shift experienced by the additional qubit 5C.

For example, the classical memory 610 of the controller 30 may store a phase accumulator corresponding to each qubit confined by the confinement apparatus 50. The phase accumulator corresponding to a respective qubit may be periodically, regularly, and/or constantly updated or updated in a triggered manner to reflect the phase accumulated by the respective qubit. In various embodiments, the memory 610 stores executable instructions for calculating and/or determining information corresponding to an AC Zeeman shift experienced by a respective qubit based on the respective qubit's distance from the target location 55 (which controls the amplitude/intensity of the dressing field experienced by the respective qubit), the gate time period (e.g., the elapsed time between the first time t₁ and the second time t₂) or the time elapsed between the initial time and the third time (e.g., t₃−t₀), and/or other information corresponding to the AC Zeeman shift experienced by the respective qubit. In an example embodiment, the memory 610 stores executable instructions for using the information regarding the AC Zeeman shift experienced by the respective qubit for updating the phase accumulator corresponding to the respective qubit. A processing device 605 of the controller 30 executes the executable instructions to cause the controller to determine information corresponding to respective AC Zeeman shifts imparted to one or more additional qubits, store the information corresponding to the respective AC Zeeman shifts imparted to the one or more additional qubits, update the phase accumulators corresponding to the one or more additional qubits based on the information corresponding to the respective AC Zeeman shifts imparted to the one or more additional qubits, and/or the like, in various embodiments.

In various embodiments, the phase accumulators corresponding to respective qubits may be used to perform one or more quantum error correction tasks corresponding to the respective qubits, adjust and/or control the phase of one or more laser beams caused to be incident on the respective qubits, and/or the like.

At step 512, the controller 30 may cause at least one of the two or more target qubits 5A, 5B to be transported out of the target location 55. For example, the controller 30 controls operation of one or more voltage and/or current sources 80 (e.g., via one or more driver controller elements 615) to cause at least one of the target qubits 5A, 5B to be transported out of the target location 55. For example, if a target qubit 5A was being stored at the target location 55 but is now to be subjected to one or more quantum logic operations, the target qubit 5A may be transported out of the target location 55 and to a quantum operation section, a gate zone, and/or the like defined at least in part by the confinement apparatus 50. In an instance where at least one of the target qubits 5A, 5B is to remain in the target location 55 (e.g., to be gated and/or interact with a different target qubit and/or to experience another clock state generation procedure), the controller 30 controls operation of one or more voltage and/or current sources (e.g., via one or more driver controller elements 615) to cause the at least one of the target qubits 5A, 5B to continue to be located in the target location 55.

### Technical Advantages

For large quantum charge-coupled device (QCCD)-based quantum computers that use hyperfine splitting qubits, operating at a low magnetic field amplitude (e.g., less than 10 G) enables a uniform magnetic field to be provided through the quantum processor. Additionally, the quantum processor is operated at a magnetic field amplitude greater than 0 G to enable the energy splitting of the hyperfine states. Generally, a set of low F (e.g., F=0, 1, and/or 2), m=0 states are used to define a qubit sub-space of the qubits. However, these m=0 states only act as clock states at 0 G magnetic field amplitude. Thus, when operating in with a magnetic field having an amplitude in the 2-5 G range, the m=0 states are not clock states (e.g., they have energies/frequencies that are sensitive to changes in the magnetic field). This leads to conventional QCCD-based quantum computers using hyper splitting qubits to experience memory errors and/or reduced memory coherence time. Therefore, technical problems exist regarding elongating the coherence time of hyper splitting qubits of QCCD-based quantum computers.

Various embodiments provide technical solutions to these technical problems. For example, various embodiments provide for controlling the sensitivity of a qubit to an external magnetic field. For example, in various embodiments, a dressing field is generated at a target location. The dressing field causes an energy structure of a qubit located at the target location to be modified such that a set of initial states of the qubit located at the target location is caused to form a set of superposition states. The set of super position states include a first dressed state of the set of superposition states includes a non-zero contribution from a first qubit state of the set of initial states and a second dressed state of the set of superposition states includes a non-zero contribution from a second qubit state of the set of initial states. The first dressed state and the second dressed state behave effectively as clock states at the operating magnetic field amplitude/magnitude of the system. As the first dressed state and the second dressed state behave effectively as clock states, the coherence time of the qubit is effectively infinite while the qubit is in the first dressed state and/or the second dressed state. Therefore, various embodiments provide for elongating qubit coherence time, which reduces memory errors and enables performance of deeper quantum circuits. Therefore, various embodiments provide improvements over conventional QCCD-based quantum computers.

Moreover, performance of conventional quantum logic gates requires radiating fields such as laser beams, microwaves, and/or the like to enact, mediate, and/or cause the entanglement of qubits. However, these radiating fields may lead to various gate errors such as photon scattering and/or affecting transitions in spectator qubits, which can lead to crosstalk problems, phase noise, and/or the like. These gate errors can lead to low fidelity logic gates and noisy computations. Moreover, quantum logic gates that use radiating fields are highly sensitive to the state of one or more motional modes of the qubits. Therefore, spin-motion coupling can lead to additional gate errors and/or a significant amount of time is needed to cool the qubits to close to their motional ground states prior to performance of a quantum logic gate. Thus, various technical problems exist regarding the performance of quantum logic gates.

On possible technical solution to these technical problems is the use of non-zero magnetic field gradients to enact, mediate and/or cause the entanglement of qubits. However, for such an interaction to be performed in a reasonable amount of time, this would require the qubits to be sensitive to magnetic fields. Conventionally, causing qubits to be sensitive to magnetic fields includes performing a shelving process where the qubit states of the qubit are shelved to states outside of the qubit sub-space that are sensitive to magnetic fields. However, this shelving is performed by driving the transition from the qubit states to the shelved states with lasers, which can lead to crosstalk problems, phase noise, and/or the like. Therefore, technical problems exit regarding the performance of quantum logic gates.

Various embodiments provide technical solutions to these technical problems. In particular, rather than shelving the qubits to enable a non-zero magnetic field gradient to enact, mediate, and/or cause the entanglement of two or more qubits, a dressing field may be applied to the two or more qubits. The dressing field causes the respective energy structures of qubits located at the target location to be modified such that respective sets of initial states of the qubits located at the target location is caused to form respective sets of superposition states. The set of superposition states include a first dressed state of the set of superposition states that includes a non-zero contribution from a first qubit state of the set of initial states and a second dressed state of the set of superposition states that includes a non-zero contribution from a second qubit state of the set of initial states. The first dressed state and the second dressed state are more sensitive to external magnetic fields than the qubit states. A non-zero magnetic field gradient present at the target location may then enact, mediate, and/or cause the entanglement of the two or more qubits. Therefore, various embodiments provide for performance of multiple qubits gates without the use of lasers and various errors (such as crosstalk, phase noise, and/or the like) that may be introduced by the use of lasers in such a system. Therefore, various embodiments provide improvements over conventional QCCD-based quantum computers.

### Example Controller

In various embodiments, a controller 30 is configured to control one or more components of a quantum system 100 configured to perform multiple qubit gates using a dressing field and a non-zero magnetic field gradient and/or to perform clock state generation procedures. For example, in various embodiments, a controller 30 is configured to control one or more components of a quantum system 100 to cause the quantum system to perform multiple qubit gates using a dressing field and a non-zero magnetic field gradient and/or to perform clock state generation procedures.

For example, in various embodiments, a confinement apparatus 50 and an associated at least one dressing field circuit 70 that define, at least in part, at least one target location 55 are part of a QCCD-based quantum system 100. In an example embodiment, at least one target location 55 is associated with a magnetic field source 90. In various embodiments, the QCCD-based quantum system 100 comprises a controller 30 configured, for example, to control operation of various components of a quantum processor 115.

For example, the controller 30 is configured to control the voltage and/or current sources 80 configured to provide voltage signals and/or current signals to the sequences of control electrodes 212 of the confinement apparatus 50 and/or the dressing field circuit 70 (and possibly one or more magnetic field sources 90 that include electromagnets). For example, the controller 30 is configured to control one or more manipulation sources (e.g., lasers 60, microwave sources 62) configured to generate and/or provide respective manipulation signals (e.g., laser beams, microwave signals). The controller 30 may be further configured to control a cryogenic system and/or vacuum system controlling the temperature and pressure within the cryogenic and/or vacuum chamber 40, and/or other systems controlling the environmental conditions (e.g., temperature, humidity, pressure, and/or the like) within the cryogenic and/or vacuum chamber 40. In various embodiments, the controller 30 may be further configured to manipulate and/or cause a controlled evolution of quantum states of one or more qubits confined by the confinement apparatus 50.

As shown in FIG. 6, in various embodiments, the controller 30 comprises various controller elements including processing device 605, memory 610, driver controller elements 615, a communication interface 620, analog-digital converter elements 625, and/or the like. For example, the processing device 605 may comprise processing elements, programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, controllers, and/or the like. The term circuitry may refer to an entirely hardware embodiment or a combination of hardware and computer program products. In an example embodiment, the processing device 605 of the controller 30 comprises a clock and/or is in communication with a clock. In various embodiments, the processing device 605 of the controller 30 is configured to execute executable instructions compiled in accordance with quantum assembly (QASM) and/or another quantum intermediate representation (QIR) compilation process.

For example, the memory 610 may comprise non-transitory memory such as volatile and/or non-volatile memory storage such as one or more of as hard disks, ROM, PROM, EPROM, EEPROM, flash memory, MMCs, SD memory cards, Memory Sticks, CBRAM, PRAM, FeRAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various embodiments, the memory 610 may store qubit records corresponding the qubits of quantum computer (e.g., in a qubit record data store, qubit record database, qubit record table, and/or the like), a calibration table, an executable queue, computer program code (e.g., in a one or more computer languages, specialized controller language(s), and/or the like), and/or the like. In an example embodiment, execution of at least a portion of the computer program code stored in the memory 610 (e.g., by the processing device 605) causes the controller 30 to perform one or more steps, operations, processes, procedures and/or the like described herein for performing multiple qubit gates using a dressing field and a non-zero magnetic field gradient (e.g., without the use of a laser beam) and/or performing a clock state generation procedure.

In various embodiments, the driver controller elements 615 may include one or more drivers and/or controller elements each configured to control one or more drivers. In various embodiments, the driver controller elements 615 may comprise drivers and/or driver controllers. For example, the driver controllers may be configured to cause one or more corresponding drivers to be operated in accordance with executable instructions, commands, and/or the like scheduled and executed by the controller 30 (e.g., by the processing device 605). In various embodiments, the driver controller elements 615 may enable the controller 30 to operate one or more manipulation sources (e.g., lasers 60 and/or microwave sources 62) to provide optical beams or microwave signals, respectively, cause voltage and/or current sources 80 to provide respective voltage signals and/or current signals to respective control electrodes 214 and/or dressing field circuits 70 (and possibly magnetic field sources 90 that include electromagnets), and/or the like. In various embodiments, the driver controller elements 615 enable the controller 30 to control and/or operate various drivers (e.g., laser drivers; microwave source drivers, AWGs, DACs, vacuum component drivers; cryogenic and/or vacuum system component drivers; and/or the like).

In various embodiments, the controller 30 comprises means for communicating and/or receiving signals from one or more optical receiver components and/or photodetectors such as cameras, MEMs cameras, CCD cameras, photodiodes, photomultiplier tubes, and/or the like. For example, the controller 30 may comprise one or more analog-digital converter elements 625 configured to receive signals from one or more optical receiver components, calibration sensors, and/or the like.

In various embodiments, the controller 30 may comprise a communication interface 620 for interfacing and/or communicating with a computing entity 10. For example, the controller 30 may comprise a communication interface 620 for receiving executable instructions, command sets, and/or the like from the computing entity 10 and providing output received from the quantum computer 110 (e.g., from an optical collection system) and/or the result of a processing the output to the computing entity 10. In various embodiments, the computing entity 10 and the controller 30 may communicate via a direct wired and/or wireless connection and/or one or more wired and/or wireless networks 20.

### Example Computing Entity

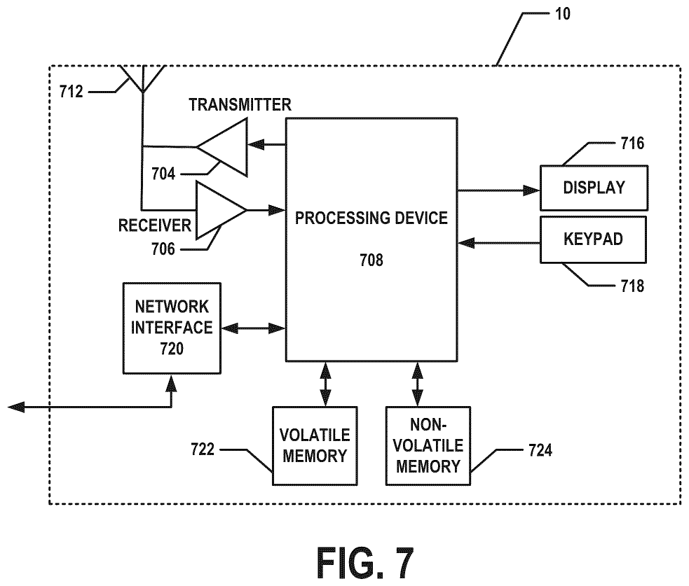

FIG. 7 provides an illustrative schematic representative of an example computing entity 10 that can be used in conjunction with embodiments of the present invention. In various embodiments, a computing entity 10 is configured to allow a user to provide input to the quantum computer 110 (e.g., via a user interface of the computing entity 10) and receive, display, analyze, and/or the like output from the quantum computer 110.

As shown in FIG. 7, a computing entity 10 can include an antenna 712, a transmitter 704 (e.g., radio), a receiver 706 (e.g., radio), and a processing device 708 that provides signals to and receives signals from the transmitter 704 and receiver 706, respectively. The signals provided to and received from the transmitter 704 and the receiver 706, respectively, may include signaling information/data in accordance with an air interface standard of applicable wireless systems to communicate with various entities, such as a controller 30, other computing entities 10, and/or the like. In this regard, the computing entity 10 may be capable of operating with one or more air interface standards, communication protocols, modulation types, and access types. In various embodiments, the computing entity 10 comprises a network interface 720 configured to enable communication between the computing entity 10 and the controller 30 and/or various other computing apparatuses.

For example, the computing entity 10 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 10 can also download changes, add-ons, and updates, for instance, to its firmware, software (e.g., including executable instructions, applications, program modules), and operating system.

The computing entity 10 may also comprise a user interface device comprising one or more user input/output interfaces (e.g., a display 716 and/or speaker/speaker driver coupled to a processing device 708 and a touch screen, keyboard, mouse, and/or microphone coupled to a processing device 708). For instance, the user output interface may be configured to provide an application, browser, user interface, interface, dashboard, screen, webpage, page, and/or similar words used herein interchangeably executing on and/or accessible via the computing entity 10 to cause display or audible presentation of information/data and for interaction therewith via one or more user input interfaces. The user input interface can comprise any of a number of devices allowing the computing entity 10 to receive data, such as a keypad 718 (hard or soft), a touch display, voice/speech or motion interfaces, scanners, readers, or other input device. In embodiments including a keypad 718, the keypad 718 can include (or cause display of) the conventional numeric (0-9) and related keys (#, *), and other keys used for operating the computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 10 can collect information/data, user interaction/input, and/or the like.

The computing entity 10 can also include volatile storage or memory 722 and/or non-volatile storage or memory 724, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 10.

### CONCLUSION

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for performing a multiple qubit gate on two or more qubits confined by a confinement apparatus, the method comprising:
controlling, by a controller, operation of a dressing field circuit to cause the dressing field circuit to generate a dressing field at a target location defined at least in part by the confinement apparatus, wherein the dressing field is configured to modify respective energy structures of the two or more qubits disposed at the target location by causing a set of initial states of a respective qubit of the two or more qubits to form a set of superposition states, a first dressed state of the set of superposition states includes a non-zero contribution from a first qubit state of the set of initial states and a second dressed state of the set of superposition states includes a non-zero contribution from a second qubit state of the set of initial states, the first dressed state and the second dressed state being more sensitive to magnetic fields than the first qubit state and the second qubit state, wherein a non-zero magnetic field gradient is present at the target location and mediates an entanglement of the two or more qubits disposed at the target location; and
after a gate time passes, controlling, by the controller, operation of the dressing field circuit to cause the dressing field circuit to stop generating the dressing field at the target location such that the respective energy structures of the two or more qubits revert to respective initial energy structures including the set of initial states.

2. The method of claim 1, wherein the dressing field circuit stops generating the dressing field at the target location, the respective energy structures of the two or more target qubits revert to an initial energy structure including the set of initial states of the qubit.

3. The method of claim 1, wherein the operation of the dressing field circuit is controlled such that when the dressing field circuit starts generating the dressing field, an amplitude of the dressing field increases from zero to a gate amplitude over a time period that is longer than a reciprocal of a frequency difference between the first dressed state and the second dressed state.

4. The method of claim 1, wherein the operation of the dressing field circuit is controlled such that when the dressing field circuit stops generating the dressing field, an amplitude of the dressing field decreases from a gate amplitude to zero over a time period that is longer than a reciprocal of a frequency difference between the first dressed state and the second dressed state.

5. The method of claim 1, wherein the operation of the dressing field circuit is controlled such that the dressing field is turned on and turned off adiabatically.

6. The method of claim 1, wherein controlling operation of the dressing field circuit comprises controlling operation of a current source or voltage source configured to provide a respective one of current or voltage to the dressing field circuit.

7. The method of claim 1, wherein the dressing field is a microwave field.

8. A method for performing a clock state generation procedure on one or more target qubits confined by a confinement apparatus, the method comprising:
controlling, by a controller, operation of a dressing field circuit to cause the dressing field circuit to generate a dressing field at a target location defined at least in part by the confinement apparatus, wherein the dressing field is configured to modify respective energy structures of the one or more target qubits disposed at the target location by causing respective sets of initial states of the one or more target qubits to form respective sets of superposition states, a first dressed state of the respective sets of superposition states includes a non-zero contribution from a first qubit state of the respective sets of initial states and a second dressed state of the respective sets of superposition states includes a non-zero contribution from a second qubit state of the respective sets of initial states, wherein a substantially uniform magnetic field has an operational magnetic field amplitude across the confinement apparatus and the first dressed state and the second dressed state behave effectively as clock states at the operational magnetic field amplitude.

9. The method of claim 8, wherein the first dressed state is formed by coupling a first two or more states of the initial set of states and the second dressed state is formed by coupling a second two or more states of the initial set of states.

10. The method of claim 9, wherein the coupling of the first two or more states and the coupling of the second two or more states of the initial set of states causes an AC Zeeman shift with a linear dependence on magnetic field having a same magnitude and opposite sign as an energy dependence on an external magnetic fields of the first qubit state and the second qubit state.

11. The method of claim 8, further comprising prior to transporting the one or more qubits, controlling operation of the dressing field circuit to cause the dressing field circuit to stop generating the dressing field at the target location such that respective energy structures of the one or more qubits revert to an initial energy structure including the respective sets of initial states of the one or more qubits.

12. The method of claim 8, wherein the operation of the dressing field circuit is controlled such that when the dressing field circuit starts generating the dressing field, an amplitude of the dressing field increases from zero to a dressing amplitude over a time period that is longer than a reciprocal of a frequency difference between the first dressed state and the second dressed state.

13. The method of claim 8, wherein the operation of the dressing field circuit is controlled such that the dressing field is turned on and turned off adiabatically.

14. The method of claim 8, wherein controlling operation of the dressing field circuit comprises controlling operation of a current source or voltage source configured to provide a respective one of current or voltage to the dressing field circuit.

15. The method of claim 8, wherein the dressing field is a microwave field.

16. The method of claim 8, further comprising controlling operation of one or more manipulation sources to generate and provide respective manipulation signals such that the respective manipulation signals are incident on the one or more target qubits located at the target location; the respective manipulation signals cause a single qubit gate or a multiple qubit gate to be performed on the one or more target qubits; and at least one of the respective frequencies of the respective manipulation signals or a frequency difference between the respective manipulation signals corresponds to a frequency difference between the first dressed state and the second dressed state.

17. The method of claim 8, wherein the clock state generation procedure is performed to elongate a qubit coherence time of the one or more target qubits.

18. A system configured to perform a multiple qubit gate on two or more target qubits, the system comprising:
a confinement apparatus configured to confine a plurality of qubits, the plurality of qubits including the two or more target qubits;
a dressing field circuit, the dressing field circuit and the confinement apparatus defining, at least in part, a target location;
a magnetic field source configured to generate a non-zero magnetic field gradient at the target location; and
a controller configured to control operation of the dressing field circuit, the controller configured to control operation of the dressing field circuit to cause the multiple qubit gate to be performed on the two or more target qubits located at the target location by performing:
controlling operation of the dressing field circuit to cause the dressing field circuit to generate a dressing field at the target location defined at least in part by the confinement apparatus, wherein the dressing field is configured to modify respective energy structures of the two or more target qubits disposed at the target location by causing a set of initial states of a respective qubit of the two or more target qubits to form a set of superposition states, a first dressed state of the set of superposition states includes a non-zero contribution from a first qubit state of the set of initial states and a second dressed state of the set of superposition states includes a non-zero contribution from a second qubit state of the set of initial states, the first dressed state and the second dressed state being more sensitive to magnetic fields than the first qubit state and the second qubit state, wherein the non-zero magnetic field gradient is present at the target location and mediates an entanglement of the two or more target qubits disposed at the target location, and
after a gate time passes, controlling operation of the dressing field circuit to cause the dressing field circuit to stop generating the dressing field at the target location such that the respective energy structures of the two or more qubits revert to respective initial energy structures including the set of initial states.

19. The system of claim 18, wherein when the dressing field circuit stops generating the dressing field at the target location, the respective energy structures of the two or more target qubits revert to an initial energy structure including the set of initial states of the qubit.

20. The system of claim 18, wherein the operation of the dressing field circuit is controlled such that when the dressing field circuit starts generating the dressing field, an amplitude of the dressing field increases from zero to a gate amplitude over a time period that is longer than a reciprocal of a frequency difference between the first dressed state and the second dressed state.

21. The system of claim 18, wherein the operation of the dressing field circuit is controlled such that when the dressing field circuit stops generating the dressing field, an amplitude of the dressing field decreases from a gate amplitude to zero over a time period that is longer than a reciprocal of a frequency difference between the first dressed state and the second dressed state.

22. The system of claim 18, wherein the operation of the dressing field circuit is controlled such that the dressing field is turned on and turned off adiabatically.

23. The system of claim 18, wherein controlling operation of the dressing field circuit comprises controlling operation of a current source or voltage source configured to provide a respective one of current or voltage to the dressing field circuit.

24. The system of claim 18, wherein the dressing field is a microwave field.

25. The system of claim 18, wherein the dressing field circuit is disposed on the confinement apparatus.

26. The system of claim 25, wherein the dressing field circuit is lithographically printed on a surface of the confinement apparatus.

27. A system configured to perform a clock state generation procedure on one or more target qubits, the system comprising:
a confinement apparatus configured to confine a plurality of qubits, the plurality of qubits including the one or more target qubits;
a dressing field circuit, the dressing field circuit and the confinement apparatus defining, at least in part, a target location; and
a controller configured to control operation of the dressing field circuit, the controller configured to control operation of the dressing field circuit to cause the clock state generation procedure to be performed on the one or more target qubits located at the target location by performing:
controlling operation of the dressing field circuit to cause the dressing field circuit to generate a dressing field at the target location defined at least in part by the confinement apparatus, wherein the dressing field is configured to modify respective energy structures of the one or more target qubits disposed at the target location by causing respective sets of initial states of the one or more target qubits to form respective sets of superposition states, a first dressed state of the respective sets of superposition states includes a non-zero contribution from a first qubit state of the respective sets of initial states and a second dressed state of the respective sets of superposition states includes a non-zero contribution from a second qubit state of the respective sets of initial states, wherein a substantially uniform magnetic field has an operational magnetic field amplitude across the confinement apparatus and the first dressed state and the second dressed state behave effectively as clock states at the operational magnetic field amplitude.

28. The system of claim 27, wherein the first dressed state is formed by coupling a first two or more states of the initial set of states and the second dressed state is formed by coupling a second two or more states of the initial set of states.

29. The system of claim 28, wherein the coupling of the first two or more states and the coupling of the second two or more states of the initial set of states causes an AC Zeeman shift with a linear dependence on magnetic field having a same magnitude and opposite sign as an energy dependence on an external magnetic fields of the first qubit state and the second qubit state.

30. The system of claim 27, wherein the operation of the dressing field circuit is controlled such that when the dressing field circuit starts generating the dressing field, an amplitude of the dressing field increases from zero to a dressing amplitude over a time period that is longer than a reciprocal of a frequency difference between the first dressed state and the second dressed state.

31. The system of claim 27, wherein the operation of the dressing field circuit is controlled such that when the dressing field circuit stops generating the dressing field, an amplitude of the dressing field decreases from a dressing amplitude to zero over a time period that is longer than a reciprocal of a frequency difference between the first dressed state and the second dressed state.

32. The system of claim 27, wherein the operation of the dressing field circuit is controlled such that the dressing field is turned on and turned off adiabatically.

33. The system of claim 27, wherein controlling operation of the dressing field circuit comprises controlling operation of a current source or voltage source configured to provide a respective one of current or voltage to the dressing field circuit.

34. The system of claim 27, wherein the dressing field is a microwave field.

35. The system of claim 27, wherein the dressing field circuit is disposed on the confinement apparatus.

36. The system of claim 35, wherein the dressing field circuit is lithographically printed on a surface of the confinement apparatus.

37. The system of claim 27, wherein the controller is further configured to perform controlling operation of one or more manipulation sources to generate and provide respective manipulation signals such that the respective manipulation signals are incident on the one or more target qubits located at the target location; the respective manipulation signals cause a single qubit gate or a multiple qubit gate to be performed on the one or more target qubits; and at least one of the respective frequencies of the respective manipulation signals or a frequency difference between the respective manipulation signals corresponds to a frequency difference between the first dressed state and the second dressed state.

38. The system of claim 27, wherein the clock state generation procedure is performed to elongate a qubit coherence time of the one or more target qubits.
